(19) United States
(12) Patent Application Publication
(10) Pub. No.: US 2026/0236824 A1
(43) Pub. Date: Aug. 13, 2026

(54) SYSTEMS AND METHODS FOR ENHANCING MODEL ROBUSTNESS

(71) Applicant: Wells Fargo Bank, N.A., San Francisco, CA (US)

(72) Inventors: Joel Vaughan, Charlotte, NC (US); Vijayan Nair, Matthews, NC (US); Arun R. Prakash, Bangalore (IN); Anwesha Bhattacharyya, Gaithersburg, MA (US)

(21) Appl. No.: 19/048,809

(22) Filed: Feb. 7, 2025

(51) Int. Cl. G06N 20/00

(52) U.S. Cl. CPC G06N 20/00

(57) ABSTRACT

Systems, apparatuses, methods, and computer program products are disclosed for dynamic model robustness evaluation. An example method includes receiving a robustness assessment request and retrieving (i) a model, (ii) a dataset, and (iii) a corresponding response set. The example method further includes determining a data correlation set and generating an adaptive noise scale set for each observation of the plurality of observations. The example method further includes generating an adaptive perturbed response set and determining a robustness result. The example method further includes causing performance of a robustness management action

### BACKGROUND

An overfit model (e.g., machine learning model) may not generalize well to unseen data. As a result, entities that train and/or deploy machine learning models often attempt to evaluate model robustness to mitigate model overfitting.

### BRIEF SUMMARY

Datasets are often used to train machine learning models. For example, during training, the data elements included in a dataset may be provided to a machine learning model. The provided dataset (e.g., a training dataset) may include inputs and/or outputs that the machine learning model may utilize to identify and ultimately learn various patterns and/or relationships that are present in the provided dataset. However, a machine learning model's reliance on particular training data to learn various patterns and/or relationships exposes the machine learning model and an entity (e.g., an individual, a company, or the like) that deploys or uses the machine learning model to unique risks. For example, during training, a machine learning model may not only learn relevant patterns and relationships from the training data, but may also learn features that are derived from noise (e.g., irrelevant features present in training data). In this regard, the machine learning model may overfit to the training data, causing the machine learning model to perform poorly on unseen data. As a result, thoughtful model robustness assessments are required to ensure that a machine learning model produces accurate predictions and/or classifications in response to receiving an input that deviates from the data that the machine learning model used for training.

To prevent the training and/or the deployment of nonrobust machine learning models, entities that train and/or deploy machine learning models may utilize a variety of different data collection techniques to ensure that the datasets that are used to train machine learning models comprise high quality data (e.g., complete datasets, accurate data elements, or the like) that is less likely to cause model overfitting. For example, while collecting data, an entity may perform data quality assessments that evaluate the quality of the collected data by checking for the completeness, accuracy, or the like, associated with the collected data before the entity uses the collected data to train a machine learning model. As an example, an entity may evaluate and remove outliers from a dataset.

Moreover, such entities that train and/or deploy machine learning models may utilize model evaluation techniques, such as by evaluating a model using holdout sets, in an attempt to prevent model overfitting. For example, an entity may split a dataset into a training set, a holdout set, and a test set. In this regard, the training set may be used for training a model with a variety of different combinations of hyperparameters (e.g., learning rate, batch size, and/or the like) and their corresponding values. Following the completion of a training iteration that is associated with a particular combination of hyperparameters and their corresponding values, performance of the model may be evaluated using the holdout set (e.g., by comparing the model's performance on the holdout set using the particular combination of hyperparameters and corresponding ground truth data and/or expected outcomes). Following the evaluation of a variety of combinations of hyperparameters and their corresponding values, the entity may select a combination of hyperparameters for the model that optimize model performance on the holdout set. After selecting hyperparameters, the model may be run on the test set to confirm whether the model effectively generalizes to unseen data.

While utilizing data collection techniques and/or holdout sets may help prevent overfitting, the effectiveness of these techniques is limited because they do not account for all possible variations in unseen data, and thus do not guarantee that a model will not generalize to noise and/or will perform effectively on shifting data distributions. For example, the performance of data collection techniques that remove particular data elements from datasets may introduce their own biases to the machine learning model and/or may fail to keep the data elements that correspond to the full variability of real-world scenarios. Additionally, if the data included in a holdout set does not adequately represent real-world data shifts that may naturally occur, a model that performs well on the holdout set risks poor performance in a production environment. To this end, data collection techniques and/or holdout sets do not effectively prevent a model from producing inaccurate and/or unstable outputs when a data distribution naturally shifts over time (e.g., due to a change in distribution of predictors, a change in distribution of a response, changes in the conditional distribution of a response given particular covariates, or the like).

To determine whether a machine learning model is robust, many entities that train and/or deploy machine learning models may evaluate the robustness of a machine learning model by introducing perturbations to data included in datasets that may in turn be provided to the machine learning model. Subsequently, the entity may evaluate the machine learning model's response when the perturbed input is provided to the machine learning model. For instance, the entity may compare the machine learning model generated responses that are generated based on nonperturbed data to the machine learning model generated responses that are generated based on perturbed data to ultimately determine whether the perturbations that were introduced to the data have resulted in the degradation of the performance of the machine learning model. For example, assume a machine learning model is trained for text classification. In this regard, to assess model robustness, an entity may employ a data alteration technique that may involve changing a data in a dataset (e.g., words to synonyms or misspellings) and comparing the classification outputs of the unaltered text to the classification outputs of the altered text.

While traditional perturbation techniques may be used to evaluate model robustness, traditional techniques often apply uniform numeric perturbations across a dataset. These perturbations are typically small, which allows for an evaluator (e.g., an entity evaluating model robustness) to determine the sensitivity of a particular machine learning model to minor changes in input data that may mimic real-world scenarios where the input data may not be perfectly aligned with the distribution of stored data (e.g., training data, holdout sets, or the like) that was used to train a machine learning model. For example, a perturbation technique that injects noise into the dataset may add the same amount of noise to every feature (e.g., covariate) in the dataset. However, because these perturbations are uniform, they do not consider the context in which the data exists, and thus may push the data outside realistic bounds (e.g., outside a data envelope).

Moreover, the above-described traditional perturbation techniques are not effective when perturbing categorical features of a dataset (e.g., gender, race, socioeconomic class, weather, or the like) because the notion of a small perturbation is not trivial for categorical variables. As a result, the perturbation of categorical variables (e.g., via a random shuffle of categorical values) that have strong associations with numeric predictors may distort the data envelope. For example, assume ‘season’ and ‘temperature’ are categorical and numerical predictors respectively in a dataset. In this regard, a perturbation of season (e.g., from summer to fall) may inherently imply a large change in temperature. And while some categorical variables with multiple levels may be perturbed via an ad-hoc technique that intuitively determines what a small perturbation is (e.g., for a categorical variable, such as weather, a perturbation from foggy to rainy may be determined to be smaller than a perturbation from foggy to sunny), the use of ad-hoc perturbation have many drawbacks. For example, ad-hoc techniques often rely upon the intuition of the entity performing the perturbation. In this regard, the determination of what may constitute a small perturbation may be subjective and/or biased, which may lead to inconsistent robustness assessments. In another example, ad-hoc techniques are not based on a numeric or probabilistic framework, and thus it is difficult to determine the size of a particular perturbation, making it difficult to compare the effects of different perturbations.

The inherent blind spots and limitations associated with accurately evaluating model robustness presents a technical problem. As such, a need exists for a solution that evaluates model robustness by (i) adaptively applying perturbations of various strength based on the distribution of particular data elements in a dataset and (ii) applying a categorical perturbation technique that is based on a pseudo-distance measure that captures the closeness between levels of a categorical variable. Example embodiments provide a technical solution to this technical problem because example embodiments do not require manual intervention. Furthermore, by leveraging local diagnostic tools, such as a population stability index (PSI) or using a supervised partitioning tree, example embodiments provide a technical solution that to identifies instabilities in the model based on adaptive numeric perturbations and/or perturbations of categorical variable.

Example embodiments described herein mitigate the above concerns by creating and using a centralized system that evaluates model robustness based on the type of data associated with a feature of a dataset. To evaluate model robustness by perturbing numeric variables, example embodiments may receive a robustness assessment request that requests the evaluation of the robustness of a particular model (e.g., a machine learning model). The robustness assessment request may be an electronic request that comprises a plurality of assessment parameters that describe the particular model robustness assessment that is requested by the robustness assessment request. For example, the plurality of assessment parameters may include a budget that defines the strength of the perturbations, a k-value that defines the number of perturbations to perform, a model identifier that identifies a particular model for evaluation, a training dataset, or the like. Example embodiments may then retrieve a model, a dataset, and a corresponding response set. The corresponding response set may be a dataset that includes a true responses or model generated responses that are based on inputs included in the dataset (e.g., a training dataset, a holdout set, or the like).

Example embodiments may then determine a data correlation set. The data correlation set may be a data structure that comprises data elements that describes the relationships between variables included in the dataset. For example, the correlation dataset may be a Pearson correlation data structure for the dataset. Example embodiments may also generate an adaptive noise scale set for each feature that is to be perturbed to evaluate the robustness of the model. As such, the adaptive noise scale set may include a value for each data element to be perturbed that scales the perturbation based on the distribution of the data in a predefined proximity (e.g., via binning) of the data element. Example embodiments may then generate an adaptive perturbed response set. The adaptive perturbed response set may be a data structure that includes a perturbation value for each data element that is to be perturbed to evaluate the robustness of the model. Example embodiments may then determine a robustness result that indicates whether the model is producing accurate and/or stable outputs in light of the performed perturbations. Example embodiments may then cause performance of a robustness management action based on the robustness result. For example, the robustness management action may cause the blacklisting of a nonrobust model.

Moreover, to evaluate model robustness by perturbing categorical variables, example embodiments may receive a robustness assessment request that requests the evaluation of the robustness of a particular model (e.g., a machine learning model). The robustness assessment request may be an electronic request that comprises a plurality of assessment parameters that describe the particular model robustness assessment that is requested by the robustness assessment request. For example, the plurality of assessment parameters may include a budget that defines the strength of the perturbations, a k-value that defines the number of perturbations to perform, a model identifier that identifies a particular model for evaluation, a dataset, or the like. Example embodiments may then retrieve a model, a dataset, and a corresponding response set. The corresponding response set may be a dataset that includes a true responses or model generated responses that are based on inputs included in the dataset (e.g., a training dataset).

Example embodiments may then determine a categorical observation set. The categorical observation set may be a data structure that includes the set of combinations of categorical observations that are present in training data. Example embodiments may then determine categorical observation subsets that that comprises combinations of categorical variables that are similar to a particular observation (e.g., observation x). Example embodiments may then generate a perturbed response set based on all categorical observation subsets that comprises each generated perturbation for a particular dataset comprising categorical values. Example embodiments may then determine a robustness result that indicates whether the model is producing accurate outputs in light of the performed perturbations. Example embodiments may then cause performance of a robustness management action based on the robustness result.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a comparison of raw and adaptive perturbations and of correlated and independent methods of perturbation for numeric variables by observing the average Frobenius norm of difference in correlation matrix of original and perturbed data.

FIG. 2 illustrates a correlation heatmap of an example Taiwan credit dataset.

FIG. 3 illustrates a robustness measure from raw and adaptive perturbations computed using different summarization metrics for GLM, XGB and FFNN models for an example Taiwan credit dataset.

FIG. 4 illustrates a comparison of model performance on original and perturbed data of Taiwan credit dataset.

FIG. 5 illustrates a comparison of models to increasing perturbations on numeric variables.

FIG. 6 illustrates a comparison of models to increasing perturbation on non-numeric variables.

FIG. 7 illustrates a comparison of robustness of models to increasing perturbations.

FIG. 8 illustrates a table that compares the correlation strength of raw and adaptive perturbations generated from correlated and independent method for a single observation and correlated variables.

FIG. 9 illustrates a distribution of perturbations of categorical variables under pseudo-distance and shuffling perturbation strategies.

FIG. 10 illustrates PSI based on observations with worst 10% rPPV for XGB model.

FIG. 11 illustrates a supervised diagnostic partition tree developed using rPPV of XGB model as response.

FIG. 12 illustrates a comparison of ArPPV for single variable perturbations.

FIG. 13a illustrates single variable diagnosis of GLM, XGB and FFNN models on ‘BILL_AMT1’ variable.

FIG. 13b illustrates a single variable diagnosis of GLM, XGB and FFNN models on ‘BILL_AMT1’ variable.

FIG. 14a illustrates a single variable diagnosis of GLM, XGB and FFNN models on ‘PAY_AMT2’ variable.

FIG. 14b illustrates a single variable diagnosis of GLM, XGB and FFNN models on ‘PAY_AMT2’ variable.

FIG. 15 illustrates a system in which some example embodiments may be used.

FIG. 16 illustrates a schematic block diagram of example circuitry embodying a system device that may perform various operations in accordance with some example embodiments described herein.

FIG. 17 illustrates an example flowchart for dynamically evaluating model robustness, in accordance with some example embodiments described herein.

FIG. 18 illustrates an example flowchart for determining an adaptive noise scale set, in accordance with some example embodiments described herein.

FIG. 19 illustrates an example flowchart for determining a perturbed dataset, in accordance with some example embodiments described herein.

FIG. 20 illustrates another example flowchart for perturbing categorical variables to evaluate model robustness, in accordance with some example embodiments described herein.

FIG. 21 illustrates another example flowchart for generating a distance set for each categorical variable, in accordance with some example embodiments described herein.

FIG. 22 illustrates another example flowchart for generating a perturbed response set, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server

### Covariate Perturbations

### Methodology

Disclosed herein is a method for assessing robustness by perturbing covariates or predictors in a dataset and examining the reduction in a model's predictive performance.

As referred to herein, a dataset to be perturbed may be defined as X^{n×p} with xᵢ denoting the iₜₕ observation vector. The corresponding true response may be denoted as yᵢ and ŷᵢ is the predicted value from a Model defined as ŷᵢ=Model (xᵢ).

The underlying approach is as follows:

For each observation x₁, xᵢ may be perturbed K times in a local neighborhood LN (xᵢ, b), where b, the budget is a measure of locality. If b=0, there is no perturbation. In some embodiments, Δxᵢₖ may denote the k^{th} perturbation on observation xᵢ with a perturbed observation being denoted as xᵢ+Δxᵢₖ.

### Summary of Perturbations

For each perturbation k of an observation i, ŷᵢₖ-ŷᵢ may be computed, which is the difference between the model prediction of a perturbed data point and model prediction of an original data point. To summarize the deviances for an observation i using root mean square across all K perturbations, example embodiments may calculate a root Perturbed Prediction Volatility (rPPV) for observation i by using the below equation,

$$r P P {V}_{i} = RMS ( {\hat{y}}_{i k} - {\hat{y}}_{i} ) = \sqrt{\frac{{\sum }_{k = 1}^{K} {( {\hat{y}}_{i k} - {\hat{y}}_{i} )}^{2}}{K}} \qquad ( 1 )$$

Example embodiments may then compute the average of rPPVᵢ across all n observations. This metric is defined as the Average root Perturbed Prediction Volatility (ArPPV), a measure of robustness.

$$A r P P V = \frac{1}{n} {\sum }_{i = 1}^{n} r P P V i \qquad ( 2 )$$

This aggregate measure can be used to compare multiple models on their local stability in predictions. It is to be noted here that the above robustness measure can be formulated using different summarization metrics. Each summarization metric will capture a different notion of robustness. For instance, one could use the mean square as a summarization metric instead of root mean square (Average Perturbed Prediction Volatility (APPV)) in cases where a measure in the same scale as Mean Squared Error (MSE) is desired. Both these formulation gives an average deviation across the K perturbed data points. Alternatively, one could use absolute maximum to estimate the largest change in prediction in the neighborhood among the K perturbed data points, providing a worst-case measure rather than an average view. Similarly, maximum square, absolute mean, absolute median, etc. are few other summarization metrics than can be used in different context. Although the above-described different summarization metrics may be used, as disclosed herein, ArPPV may be referred to as the standard metric to capture the average change in prediction for multiple perturbations.

While summarizing the variability in ŷᵢₖ, it is possible to summarize the K perturbations by their deviation from the original prediction (ŷᵢₖ-ŷᵢ) or by their deviation from the true response (ŷᵢₖ-ŷᵢ). In some examples, the model predictions are expected to be stable for small-scale perturbations, so if on average, the deviation from original prediction (ŷᵢₖ-ŷᵢ) is high for an observation i, then it is likely that the prediction is not stable at that point. On the other hand, if on average the deviation from true response (ŷᵢₖ-yᵢ) is high for an observation i, then this is a combination of model bias (ŷᵢ-yᵢ) and model stability (ŷᵢₖ-yᵢ). Thus, to understand the smoothness of the prediction surface, it is intuitive to look at (ŷᵢₖ-yᵢ). Also in cases when the response is binary and the problem is binary regression, then ŷᵢₖ denotes the predicted probability of the perturbed point and other metrics would be necessary to incorporate loss in model performance; however, a metric that simply defines stability of predictions may be obtained by using (ŷᵢₖ-yᵢ), irrespective of response type. Note that, (ŷᵢₖ-yᵢ) may also be high due to sensitivity of the model to one or more variables at the locality of observation i, particularly if there exists a sharp but systematic transition in that neighborhood. In general, it is difficult to distinguish between model sensitivity and lack of stability, and a model demonstrating instability using this metric may need to be scanned for sensitivity issues in downstream analysis.

ArPPV increases with budget b, where budget is defined as the measure of locality around the data point that is perturbed. The budget should be kept small to measure the robustness of models. For small budgets, a robust model should give stable predictions, thus producing small ArPPV values, while for large budgets, the model is expected to be sensitive to large perturbations of important variables; otherwise, the model is flat and may be underfit. Since ArPPV is not bounded above, it is more useful for comparing multiple models than being used to assess a single model in an absolute sense.

### Perturbation Strategy

Disclosed herein is a strategy to generate perturbations that are local and maintain the data envelope and inherent associations in the data. While the concept of a local neighborhood is well-defined in continuous or naturally ordered discrete variables, non-numeric or categorical variables represent a coarse segmentation of the data space, such as delinquency status of an account. Perturbing such variables from one state to the other creates a large disturbance in the system. Often the distributions of numeric variables are different in each segment and hence perturbing a categorical variable would imply that the other covariates be changed drastically as well to maintain association. Thus, perturbing such variables may not be appropriate for robustness tests in general. However, in certain circumstances, there might be a need to test the robustness of models against perturbations in these predictors (for example, a model where the majority of predictors are categorical). Keeping this in mind, example embodiments set forth a method that generates perturbations of numeric variables independent of the non-numeric (categorical) variables.

For numeric variables, multiple random perturbations may be generated from a multivariate Gaussian distribution respecting the correlation structure of the data. If all observations are perturbed by a similar amount, this is referred to herein as the raw perturbation strategy. On the other hand, a variable may not be uniformly distributed, and it may be desirable to perturb an observation lying in a dense data region less than an observation lying in a sparse region. To achieve this, example embodiments may make the size of the perturbations adaptive to the variable's density. This is referred to herein as the adaptive perturbation strategy.

For categorical variables, it is difficult to induce ‘local’ perturbations as there is no inherent concept of distance. To address this issue, a concept of pseudo-distance between categorical observations is introduced. This distance is used to create local perturbations. Additionally, embodiments disclosed herein ensure that all categorical perturbations respect the data envelope by restricting the perturbations to configurations that are present in the training data.

### Raw Perturbations for Numeric Variables

For numeric variables, the perturbations are generated from a Gaussian distribution whose correlation structure is taken from the original data. Let the estimated Pearson correlation structure be \hat{P}, then for a given budget b, the jₜₕ component of kₜₕ perturbation of observation i is obtained as

$$Δ {x}_{i k j} = {∈}_{i k j} \times b \times {σ}_{j} \qquad ( 3 )$$

$$where ,$$

$${σ}_{j} : sd ( {X}_{j} ) \qquad ( 4 )$$

$${∈}_{i k} ∼ N ( 0 , \hat{P} ) \qquad ( 5 )$$

Thus, the perturbed observation for kₜₕ perturbation of observation i is given as:

$${\tilde{X}}_{i k} = {X}_{i} + Δ {x}_{i k} \qquad ( 6 )$$

Budget (b) controls the degree of perturbation around the observation and it is incorporated as a percentage of the standard deviation of each variable (σⱼ). Hence for a variable Xⱼ with a unit variance, a 2% budget would imply a perturbation range of 0.06 around the original value with a probability of 99.7%. For a zero budget, data is not perturbed, resulting in zero ArPPV. For an increasing budget, the perturbations become larger and larger, resulting in a larger ArPPV.

Preserving the correlation in the perturbations ensures that any generated perturbations do not distort the data envelope. For instance, if a dataset has ‘inflation rate’ and ‘unemployment rate’ as two of the variables, increasing ‘inflation rate’ should result in decreased ‘unemployment rate’. This pattern should be observed in perturbed data as well. However, for low budgets, ignoring the correlation is acceptable as its impact on data distortion is extremely low.

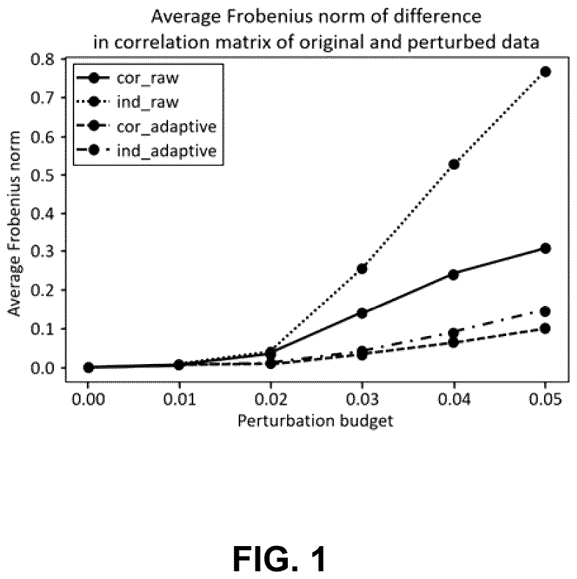

The perturbations can also be independent across the variables, and this is achieved by using the identity matrix instead of \hat{P} when generating the perturbations. It is expected that for very small budgets, correlated and independent perturbations are similar and cause no significant difference in the correlation structure of the perturbed data. As the budget increases, the difference becomes non-trivial, as shown below in FIG. 1. To respect the data envelope, the out-of-range perturbations may be modified to return to the minimum/maximum value of the variable in the original data.

### Adaptive Perturbations

In the above-described raw perturbation strategy, all observations are perturbed to the same noise scale σⱼ defined in equation (2). However, in most situations, there is considerable variation in the dataset locally. For example, data in the tails or in sparse regions usually have larger variation. Thus, intuitively a perturbation approach should take the differences in variation into account in the definition of local perturbations. To achieve this, example embodiments described herein make the perturbations adaptive by adjusting the noise scale σⱼ to \tilde{σ}ᵢⱼ where each observation ‘i’ has its own scale based on the spread of nearby points. Note that the direction of association (positive/negative) is still retained in ∈ᵢₖ in equation (3) although the scales of perturbations change for each observation.

Example embodiments may use any suitable method for determining the local measure of spread for each observation. For example, example embodiments may bucket each variable into quantile bins and computing a rolling mean of the standard deviation in each bucket. Let s_{q} be this measure of the spread in bucket q. As such, the scale of noise for observation ‘i’ lying in bucket q may be adapted as:

$${\tilde{σ}}_{i j} = \frac{{s}_{q}}{min ( max ( {s}_{q} ) , {σ}_{j} )} {σ}_{j} \qquad ( 7 )$$

If s_{q} is very small compared to max(s_{q}) or σⱼ, then \tilde{σ}ᵢⱼ becomes smaller than the original scale of perturbations. If s_{q} is greater than the global measure of spread, σⱼ then \tilde{σ}ᵢⱼ is s_{q}.

If a variable is uniformly distributed, the adaptive perturbations may be similar to the raw perturbations as s_{q}/max(s_{q}) is close to 1. When the distribution is non-uniform, the perturbations may be more conservative in dense regions and relaxed in sparse/long-tailed regions.

FIG. 1 illustrates the average Frobenius norm of difference in the correlation matrices of original and perturbed data plotted against the perturbation budget. FIG. 1 shows that for small budgets the difference between the methods is insignificant and the norm is close to 0 implying correlation structure of perturbed data is close to original data. As budget increases, the average Frobenius norm of independent perturbations increases faster than correlated perturbations. The adaptive perturbations are usually more conservative, hence the perturbed data in this case is closer to original data than in the case of raw perturbations.

### Perturbation of Discrete Variables

Once the data is perturbated, example embodiments may round the perturbed values of discrete variables to their nearest integer value to maintain the data type. This ensures that the perturbed values that are not uninterpretable or invalid for such variables. The perturbed values are thus consistent with possible values for the variable and the nature of a model's interpolation between possible values does not become a factor in the robustness test.

Note that due to this rounding up, a discrete variable can only be perturbed if the noise to be added has absolute value ≥0.5. Hence discrete variables may need either a large budget or a larger noise scale in order to be perturbed.

### Categorical Variables

In general, it is less prudent to perturb categorical variables as they often represent coarse segmentation of the population, and such perturbations may not abide the notion of local perturbations. Especially perturbing categorical variables which have strong association with numeric predictors can distort the data envelope. For example, if a dataset includes ‘season’ and ‘temperature’ as categorical and numerical predictors respectively in a dataset, then perturbing ‘season’ will imply a large change in ‘temperature’. Thus, one should be conscientious and deliberate when perturbing categorical variables.

Nevertheless, if the robustness test requires perturbation of categorical variables which are independent of other numeric variables in the data, a method is needed for perturbing them independently. The main challenge lies in the fact that there is no sense of ordering or distance between unique values or levels of these variables.

A simple way to perturb categorical variables is to randomly shuffle the value of a variable using its marginal distribution. As referred to herein, this random shuffling is referred to as the ‘shuffling’ strategy. However, there is no notion of locality (local perturbation) in this method. For instance, changing a categorical variable like ‘Gender’ from ‘Male’ to ‘Female’ may not be considered as a local perturbation because firstly it represents two very different segments of the population in multiple aspects and perturbing Gender may have a large impact on the response. Also, for variables with multiple levels in a categorical variable like ‘weather-situation,’ which may have levels like ‘foggy’, ‘rainy’, ‘sunny’, etc., changing or perturbing the ‘weather-situation’ from ‘foggy’ to ‘rainy’ is intuitively a smaller change than changing ‘foggy’ to ‘sunny’ in terms of the various attributes that define a weather situation (humidity, temperature, etc.). In such scenarios, the former change may be considered as a smaller perturbation in some sense. However, random shuffling does not consider this difference. Another drawback of random shuffling for categorical variables is that the association among variables is no longer maintained. The perturbed data may contain a combination of values for the categorical variables that do not make any logical sense and/or lie well outside of the data envelope.

As such, disclosed herein is a method for a perturbation strategy that is based on a pseudo-measure of nearness between different levels of categorical variables based on their average impact on the response.

### Pseudo-Distance Measure

Example embodiments generate a distance measure that captures closeness between the levels of plurality of categorical variables. This can be based on subject matter expertise or through careful scientific evaluation. However, without such information, data can be utilized to create a measure. Example embodiments define a pseudo-distance between levels of categorical variables based on their average impact on the response. The underlying idea is that if two levels of a categorical variable are very similar then their average impact on the response should not be very different. Note that this is a data-driven approach to induce a distance metric on the levels of the categorical variables and may not necessarily capture the true closeness which a careful science-driven approach may.

For a given categorical variable x with levels l₁, l₂, . . . , lₘ, a distance measure may be defined between any two levels lᵢ and lⱼ as the absolute difference in average response of observations at the two levels.

$$d ( x = {l}_{i} , x = {l}_{j} ) = \vert avg ( {y}_{x = {l}_{i}} ) - a v g ( {y}_{x = {l}_{j}} ) \vert = d ( x = {l}_{j} , x = {l}_{i} ) \qquad ( 8 )$$

This measure is symmetric and defines a concept of similarity based on whether the two levels have similar or different average impact on the response. Example embodiments may compute an m*m distance matrix for each categorical variable with the cell (i,j) given by d(x=lᵢ, x=lⱼ).

Example embodiments may further Min-Max scale the distance matrix so that the most disparate levels have distance 1 in order to maintain consistency among different variables and keeping a single variable from dominating the categorical perturbations.

For each categorical variable xⱼ, there is a corresponding distance matrix dⱼ. Thus, a distance between two observations x and x′ on p categorical variables may be defined as:

$$D ( x , {x}^{′} ) = {d}_{1} ( {x}_{1} , {x}_{1}^{′} ) + {d}_{2} ( {x}_{2} , {x}_{2}^{′} ) + … + {d}_{p} ( {x}_{p} , {x}_{p}^{′} ) \qquad ( 9 )$$

In some cases, example embodiments may control the number of perturbations of certain variables compared to others. In this regard, example embodiments may utilize the below modified formula to have that flexibility by giving weights to each variable.

$$D ( x , {x}^{′} ) = {w}_{1} {d}_{1} ( {x}_{1} , {x}_{1}^{′} ) + {w}_{2} {d}_{2} ( {x}_{2} , {x}_{2}^{′} ) + … + {w}_{p} {d}_{p} ( {x}_{p} , {x}_{p}^{′} ) \qquad ( 10 )$$

The weights can be based on variable importance or any other criteria. The higher the weight on a variable, the lesser the chance of that variable getting perturbed. This may be used to ensure that the important model variables are not easily perturbed during the joint perturbation. Giving more weights to sensitive variables will produce more conservative perturbations.

### Categorical Perturbation Strategy

Disclosed herein is a joint perturbation of the categorical variables based on a single budget. This budget helps in controlling the number of variables that will change in each perturbation and the levels they can take. The strategy maintains associations among variables and ensures that perturbed points lie within the data envelope. For instance, assume two variables, one being an indicator of ‘working day’ and other being the indicator of ‘Sunday’. In this regard, the ‘Sunday’ indicator would not be changed to ‘non-Sunday’ while keeping the ‘working day’ indicator as ‘False’ unless such combination exists in the data.

As referred to herein, the set of combinations of categorical observations present in the training data may be referred to as [symbol] . This is referred to as the data envelope. Now, given a budget b, for each observation x, example embodiments may define a subset of [symbol] :

$${𝒳}_{x}^{b} = \{ z ∈ 𝒳 ; D ( z , x ) \leq b * max ( D ) = b * p \} \qquad ( 11 )$$

This set now consists of combinations that are not too different from observation x when measured with the distance measure D. The amount of dissimilarity is bounded by the budget b. The perturbed values are restricted to this set. Also note that due to the Min-Max scaling of the distance matrices, max (D)=p.

For generating K perturbed versions of observation x, the set

$${𝒳}_{x}^{b}$$

may be sampled from with replacement K times. Finally, example embodiments may accept each perturbation with a probability max_prop or reject the perturbation and retain the original observation. max_prop indicates the proportion of K perturbations to be accepted for each observation.

The stochastic acceptance step ensures that there are not cases where all the perturbations change the original value of a particular variable. This is especially helpful when a single binary variable is perturbed. For example, to perturb a single binary variable, the budget must be increased to 100%, as none of the observations will get perturbed for any lower budget. But for 100% budget, all the perturbations will swap the variable's value, potentially leading to a substantial impact. Thus, the use of max_prop allows flexibility for the proportion of perturbations per observation.

Note that this strategy in essence induces a transition matrix for each observation x, which puts equal opportunity to be perturbed to all configurations in

$${𝒳}_{x}^{b}$$

and no opportunity to transition to configurations outside this set.

$$As b \to 0 ⇒ {𝒳}_{x}^{b} \to ϕ and b \to 1 ⇒ {𝒳}_{x}^{b} \to 𝒳 .$$

Thus, the pseudo-distance helps us set the transition probabilities based on a budget without having to explicitly define a (potentially large) transition matrix.

### Local Diagnosis

In addition to comparing models with respect to robustness, example embodiments may use the observation level measures of robustness (defined above) to understand the behavior of a model locally and identify regions of the data where a model shows a lack of robustness.

As discussed earlier, example embodiments may create multiple random perturbations of each observation in a local neighborhood and summarize these perturbations to quantify the smoothness of the prediction surface around that observation. As disclosed herein, the observation level measure rPPV summarizes the deviations of predictions at perturbed observations from prediction at the observed point of all perturbations of the given observation. As such, example embodiments may use this measure to identify the variables/regions contributing significantly to the volatility in the predictions. Two approaches are discussed below. The first uses the population stability index (PSI), a statistical measure that quantifies the difference between a probability distribution and a reference distribution. The second approach uses a supervised partitioning tree.

In the first approach, a threshold is chosen to identify the observations with the highest rPPV measures, for example the highest 5% observations. Example embodiments may then use a population stability index (PSI) to compute the difference between the subset of observations with the highest rPPV and the rest of the observations for each variable. By ranking the variables by their corresponding PSI, example embodiments may identify the set of variables that display maximum shift in distribution. Further diagnosing these variables will help identify regions where the response is most volatile.

In the second approach, a diagnostic supervised partition tree may be created on the covariate space using each observation's rPPV as the response. At each leaf node, the average rPPV for observations in that node is obtained. The variables of interest are those that have resulted in a node split, and particularly the nodes that result in the maximum difference between the average rPPV values of its leaf nodes. This set of variables identifies high volatility regions in the dataset and diagnosing these variables may further help reveal the causes of the volatility in the predictions of the given model.

After identifying a set of variables, each variable may be investigated separately by perturbing observations on that variable only keeping the values of other variables fixed. These single variable perturbations isolate the contribution of the selected variable to each observation's volatility, which can be visualized using a scatterplot of rPPV against the variable. This plot immediately shows the high volatility regions in this variable.

However, regions may have high rPPV due to appropriate model sensitivity rather than overfitting or problems with the model. For example, the model might be responding to interactions, transitions, or other variables, resulting in high rPPV in that region. Thus, comparing the scatterplot of rPPV vs variable with Partial Dependence Plot (PDP) of that variable helps reveal the true reason behind high rPPV regions. The PDP shows the marginal effect of a variable on the predicted outcome of a model and shows the relationship between the target response and variable. Thus, regions with high rPPV might be arising due to a transition effect in this relationship that can be observed in the PDP. The transition points and regions with large slopes on the PDP have a correspondingly high rPPV. If this transition is expected or reasonable, then the observed high ArPPV is caused by model sensitivity and should not be attributed to lack of robustness. However, if two models have similar performance and both have captured expected model activity but have different ArPPV, then the model with higher ArPPV can be deemed as less robust to small scale perturbations.

Another way to understand the behavior of the model in a local region is to check for monotonicity. As the generated perturbations are local, the model's prediction is expected to be monotonic in that small region. This can be measured by computing the number of times the prediction surface has a change in its second derivative. A robust model is expected to have a small number (0 or 1) of monotone violations. For example, a linear model will never have any monotonicity violations for local perturbations on a single variable. Capturing the number of monotone violations on the set of observations with high rPPV helps in the measuring of how unstable the model is in those regions. If an observation with high rPPV has 0 monotone violations, then the high value can be attributed to model sensitivity in the region as opposed to model instability. It is to be noted that choice of variables, budget and quality of perturbations play a crucial role is assessing robustness to small scale addition of noise in data, and thus should be carefully considered.

### Results

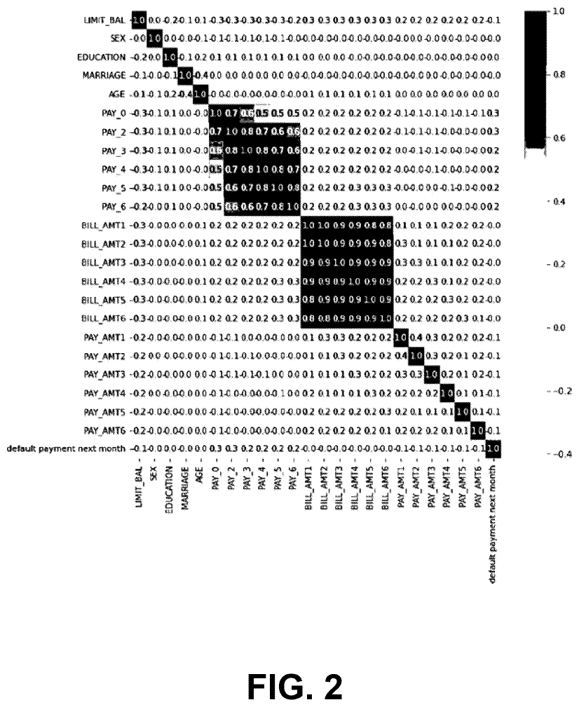

The methodology to compare the robustness of three different models is discussed below in connection with a series of figures and tables. One example of a dataset that could be used for this comparison is Yeh, I-Cheng. 2016. “default of credit card clients.” UCI Machine Learning Repository. However, this is just one example, and in other instances other datasets may be used. The dataset may contain the credit card customer's default payment status in Taiwan (henceforth referred to as Taiwan credit dataset) along with other information like gender, marital status, educational qualifications, and age. The dataset may also include monthly information regarding amount of the given credit, history of past payments, amount of bill statement and previous payments for the period April to September. The response variable is a binary indicator of default payment (1=Yes, 0=No). FIG. 2, shows a correlation heat map that indicates there are a few sets of highly correlated variables present in the dataset like ‘PAY’, ‘BILL AMT’, etc.

The three models that are compared are a Generalized Linear Model (GLM), eXtreme Gradient Boosting (XGB), and Feed Forward Neural Network (FFNN). The three models have their respective hyperparameters tuned to give optimal performance on a validation set. The performance metrics of these models are given in Table 5-1. The GLM and XGB have the same top three important variables: ‘PAY_0’, ‘BILL_AMT1’ and ‘LIMIT_BAL’. Whereas FFNN has high importance on the non-numeric variables compared to GLM and XGB. Also, XGB places more importance on ‘PAY_AMT’ variables compared to GLM and FFNN.

TABLE 5-1
Model Performance metrics

| | Metric: Log-loss | | | Metric: AUC | | |
|---|---|---|---|---|---|---|
| Model | Train | Test | Gap | Train | Test | Gap |
| GLM | 0.447 | 0.456 | 0.009 | 0.753 | 0.745 | 0.008 |
| XGB | 0.406 | 0.433 | 0.027 | 0.813 | 0.778 | 0.035 |
| FFNN | 0.421 | 0.442 | 0.021 | 0.792 | 0.765 | 0.027 |

As shown in Table 5-1, the XGB model is performing best on the test data, but it also has the highest gap between training and test set performance. The gap statistic is a measure of the degree of overfitting, and a higher gap usually indicates that the model is unable to generalize well on unseen data. Thus, robustness tests are run with ArPPV metrics to confirm whether the larger gap is cause for concern in this case.

The variables in the test dataset are perturbed using the raw and adaptive methodology described above and using the settings described in Table 5-2, with K=100 perturbations for each observation. For discrete variables, the noise scale was artificially raised to allow perturbations after rounding to the nearest integer. Categorical data needs a high budget for the same reason. As discussed above, the perturbations are independent for numeric and non-numeric (categorical) variables, and especially for this dataset there is no reason to assume any association between the categorical and numeric variables because the categorical variables SEX, EDUCATION, and MARRIAGE are subjectively unrelated to numeric variables which is also evident from the correlation heatmap shown in FIG. 2.

TABLE 5-2
Perturbation settings

| Variable type | Variables | Budget |
|---|---|---|
| Categorical | ‘SEX’, ‘EDUCATION’, ‘MARRIAGE’ | 0.2 |
| Numeric | Rest of the variables | 0.05 |

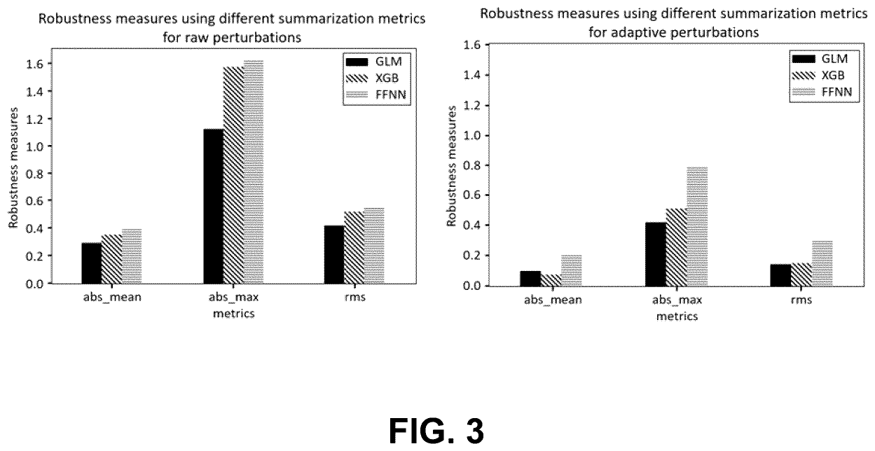

Different metrics are used to summarize the perturbations as discussed above, included ArPPV. In FIG. 3, results from summarizing the perturbations using different metrics like absolute mean, absolute maximum, and root mean square (ArPPV) is shown. The ArPPV is determined from the bars in the plot corresponding to root meat square (rms). These metrics show mostly consistent ranking of models. Based on these plots, GLM is the most robust model for most metrics, followed by XGB and then FFNN. In the case of adaptive perturbations, GLM and XGB are comparable according to absolute mean and root mean square, whereas the FFNN model is relatively more volatile.

In the case of absolute maximum, the deviations are not averaged across all perturbations but only considering the one perturbation which resulted in the maximum deviance from original prediction, naturally the values using this metric is higher than the rest and focuses on a more extreme scenario compared to the other metrics. Given that root mean square and absolute mean convey similar information in terms of ranking of the models, the summarization metric is fixed as root mean square, using ArPPV as the robustness measure.

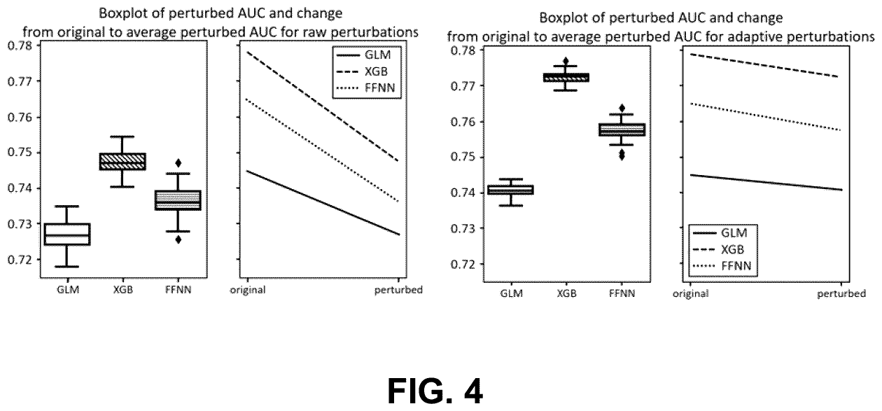

In addition, the AUC is computed for each set of perturbations using the true response values and comparing with original data as shown in FIG. 4. Similar comparisons can be performed using other metrics as well. These measures provide the performance of the models on the perturbed data, in contrast to the ArPPV, which isolates the stability of the model predictions to small perturbations.

FIG. 4 illustrates the decrease of average perturbed AUC from the original AUC for raw perturbations. Overall, XGB model still outperforms the other two models on the perturbed data and has the smallest variance on perturbed AUC as observed from the box plot. The decrease in performance for XGB and FFNN are sharper than GLM. FIG. 4 also illustrates similar information for the adaptive perturbations. XGB and GLM are similar in their AUC variance. XGB still retains higher performance in perturbed data. The analysis till this stage indicates that in spite of the larger gap, XGB model does not show significant higher volatility to perturbations in comparison to the other models.

### Effect of Budget on ArPPV

The perturbation strategies for numeric and non-numeric variables both include a measure of locality (called budget) to control the extent of perturbations of the variables. This is an important hyperparameter associated with generating perturbations since the robustness of models is tested for small-scale perturbations only. For example, if stability is tested at very high budgets, the model output is expected to change with significant changes in covariates. By its very nature, the model is expected to capture the response's relationship with its covariates, and a high-performing model will respond to significant change in its predictors. Hence all robustness tests need to be performed at low budgets.

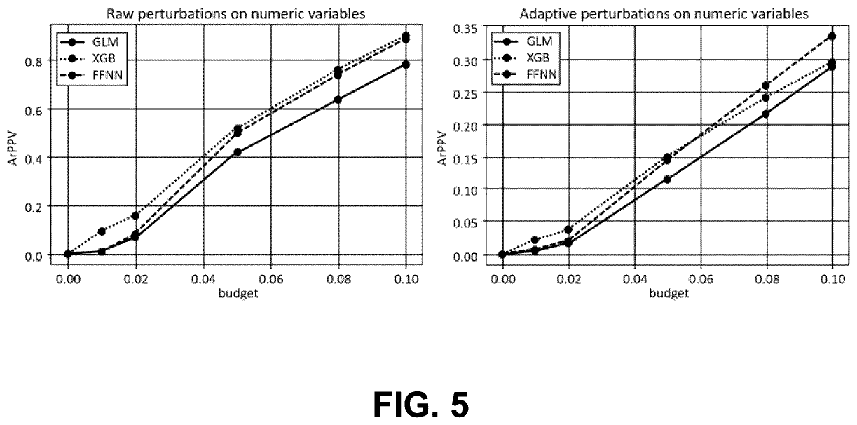

Disclosed herein are separate strategies for perturbing numeric vs non-numeric variables. The impact of these separate strategies is discussed below and illustrated in FIGS. 5-7. Consequentially, the effect of budget is demonstrated by perturbing numeric and categorical variables first separately and then simultaneously. First, as shown in FIG. 5, the effect of numeric perturbations against increasing budgets is shown via the trend in ArPPV.

In particular, FIG. 5 illustrates (i) a comparison of robustness of models to increasing raw perturbations on numeric variables and (ii) a comparison of robustness of models to increasing adaptive perturbations on numeric variables.

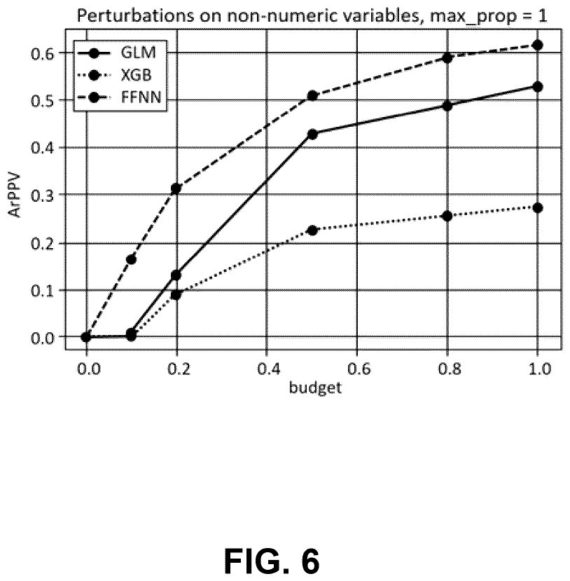

As shown in FIG. 5, the ArPPV increases with increasing budget. For lower budgets, both the GLM and FFNN have lower ArPPV than the XGB. This is consistent with gap statistics given in Table 5-1. However, as budget increase, ArPPV of FFNN rises at a greater rate than the other models. FIG. 5 also illustrates that as budget increases, XGB model becomes similar to GLM model in terms of stability in case of adaptive perturbations. However, GLM continues to be the most stable model even at higher budgets. Although at 5% budget, FFNN and XGB have similar volatility in FIG. 5, this is in contrast with earlier result in FIG. 3 which shows that FENN model has a higher ArPPV. This is because the earlier result carries impact of both numeric and non-numeric variables perturbation, which is further illustrated in FIG. 6.

FIG. 6 illustrates a comparison of robustness of models to increasing perturbation on non-numeric variables. As a result, FIG. 6 illustrates the effect of budget on ArPPV for perturbation of categorical variables (Table 5-2). As before, ArPPV increases with increasing budget as expected, with the difference that the XGB model consistently has the lowest ArPPV followed by GLM and then FFNN. Also, XGB and GLM are more stable at lower budgets than FFNN. The FFNN model gives more importance to categorical variables than the GLM and XGB models, which makes it more sensitive to perturbations in these variables. This behavior of FFNN explains why there is high ArPPV for FFNN in FIG. 3 but not when only perturbing numeric variables.

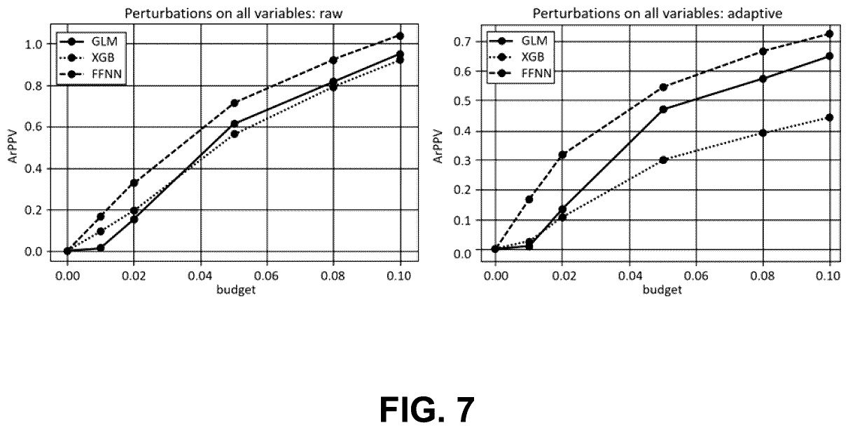

FIG. 7, illustrates a comparison of robustness of models to increasing perturbations. As such, the change in ArPPV with increasing budgets and perturbing all variables simultaneously is shown in FIG. 7. The x-axis shows the budget on numeric variables, whereas the budget of categorical variables is 5 times that budget. In particular, FIG. 7 illustrates (i) a comparison of robustness of models to increasing raw perturbations and (ii) a comparison of robustness of models to increasing adaptive perturbations.

As illustrated in FIG. 7, among the three models, FFNN remains the model with the highest ArPPV for the entire range of budgets. This is mostly because FFNN was more unstable to categorical perturbations than XGB or GLM. For small budget perturbations, both XGB and GLM have low ArPPV, although as budget increases the effect of categorical variables takes over and XGB becomes more stable than GLM, and this is more pronounced in adaptive perturbations. Due to GLM's sub-optimal performance on test dataset (Table 5-1), XGB is the preferred model based on both its performance on unseen data and robustness to small-scale perturbations.

### Correlated and Independent Perturbations for Numeric Variables

The raw perturbation method discussed above generates perturbations that respect the inherent correlation in the data. In this section, is a comparison of the correlated perturbations with perturbations that are generated independently on each variable. Here, a five percent budget for numeric variables is used. The ArPPV results are given in Table 5-3. Both correlated and independent perturbations result in similar ordering of ArPPV for the models, with the GLM having the least ArPPV followed by FFNN and XGB.

TABLE 5-3
Robustness measure ArPPV for correlated
and independent numeric perturbations.

| | ArPPV | | | |
|---|---|---|---|---|
| | Raw | | Adaptive | |
| Model | Correlated | Independent | Correlated | Independent |
| GLM | 0.422 | 0.378 | 0.118 | 0.107 |
| XGB | 0.521 | 0.456 | 0.159 | 0.152 |
| FFNN | 0.499 | 0.426 | 0.149 | 0.139 |

The independent perturbations result in smaller ArPPVs compared to correlated perturbations, even though the rank ordering between the models remains the same. This is because of the highly correlated variables as seen in FIG. 2; the importance of a given variable is shared with the variables which are highly correlated with it. Thus, correlated perturbations cause the prediction to change more in this dataset, since all the variables in the same group are perturbed in the same direction, leading to higher a ArPPV. On the other hand, for independent perturbations even though one of the variables changes, the other correlated variables may have not changed in the same direction. Sometimes these changes can be in opposing directions, and this can reduce the impact of the resulting perturbations.

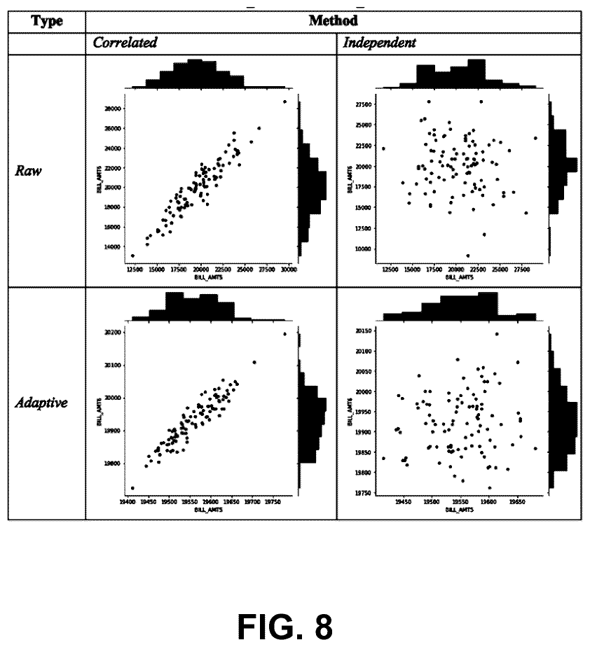

FIG. 8 illustrates a comparison of the correlation strength of raw and adaptive perturbations generated from correlated and independent method for a single observation and correlated variables. FIG. 8 depicts the perturbed values for a single observation and a scatter plot of correlated variables ‘BILL_AMT5’ and ‘BILL_AMT6’. These variables' actual value for the observation is 19549 and 19920, respectively. As shown in FIG. 8 the perturbations generated from a correlated method maintain the correlation between the two variables around the actual point, whereas the perturbations from independent methods are randomly scattered around the actual data point, and thus do not maintain the correlation.

Note that for small scale perturbations the difference in impact between correlated and independent perturbations is typically not large. However, in the rare cases where highly correlated variables are included as model predictors the difference can still be significant as seen in Table 5-3.

### Comparison of ‘Pseudo-Distance’ Method and ‘Shuffling’ Method for Categorical Variables

A comparison between the pseudo-distance and shuffling methods for perturbing categorical variables in an example dataset that comprises Taiwan credit data is discussed below. As discussed earlier, the pseudo-distance measures the difference between two levels of a categorical variable based on their average impact on the response. This means that for a given dataset, any two levels of a categorical variable are considered similar by this metric if they have a similar average impact on the response and perturbing that variable between these two levels should have a lower impact than perturbing them to a level which has a very different average response.

TABLE 5-5
Average response for each level of a categorical
variables ‘EDUCATION’ and ‘MARRIAGE’
defining the similarity among the levels.

| EDUCATION | | MARRIAGE | |
|---|---|---|---|
| Variable level | Average response | Variable level | Average response |
| graduate school | 0.197065 | married | 0.234975 |
| university | 0.234813 | single | 0.211688 |
| high school | 0.256193 | others | 0.235808 |
| others | 0.076655 | | |

For example, as shown in Table 5-5, the variable ‘MARRIAGE’, levels ‘married’ and ‘others’ are similar to each other based on their average impact on response. Here ‘others’ may include partners, divorced, separated, etc. Similarly, for ‘EDUCATION’, average proportion of default decreases from ‘high school’ to a ‘university degree’ (undergraduate), while the default rate is still lower for people with a graduate degree. According to Table 5-5, a university education and high school education are considered more similar than a university education and graduate degree. Thus, perturbing this variable from ‘university’ to ‘high school’ or ‘high school’ to ‘university’ will result in a perturbation which is small-scale and local as compared to a perturbation of ‘university’ or ‘high school’ to ‘others.’

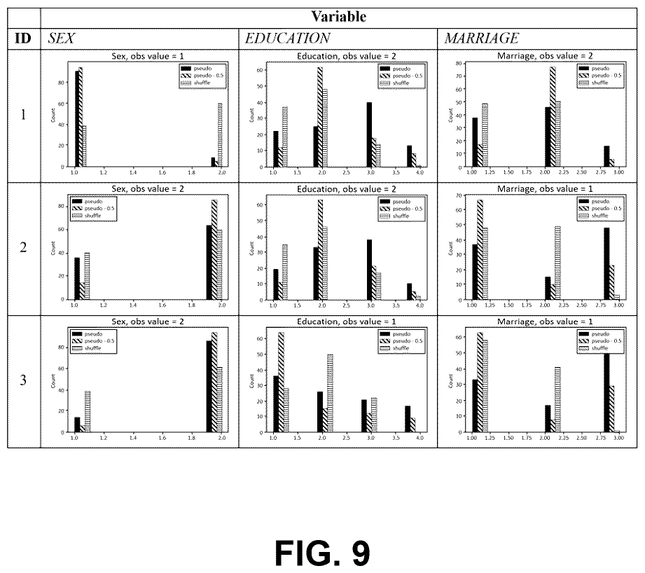

The pseudo-distance method of categorical perturbations ensures that the perturbations occur within similar levels of a variable as compared to the shuffling method where the perturbations are generated by randomly shuffling the value of a variable using its marginal distribution. To further illustrate the difference between the two methods, FIG. 9 shows a plot of the distribution of the perturbed values under the two methods. The perturbation budget for the pseudo-distance method is set at 40% and the results are plotted for two different settings of max_prop, namely max_prop=1 indicated by ‘pseudo’ and max_prop=0.5 indicated by ‘pseudo-0.5’. As discussed above in regard to the perturbation of categorical variables, max-prop indicates the proportion of K=100 perturbations to be accepted for an observation and helps in creating more controlled perturbations especially in extreme cases of binary variables. The title in each plot indicates the actual value of the variable for that observation.

FIG. 9 depicts that under the pseudo-distance strategy with max_prop=0.5, about 50% of the time an observation is unperturbed, and when it is perturbed, it prefers movement to levels that are similar to its actual level over the others. For example, the actual level (value) of ‘EDUCATION’ is 2 (university) for observation id 1. As a result, more than 50% perturbations lie at level 2 for ‘pseudo-0.5’, and it tends to move to level 3 (high school) more than any other level because level 2 has the highest similarity with level 3 as shown in Table 5-5. Similarly for observation id 2, the actual level of ‘MARRIAGE’ is 1 (married), the ‘pseudo-0.5’ strategy does not easily perturb the point, and when it indeed perturbs the point, it prefers the level with maximum similarity to level 1, i.e., level 3 (others). The ‘pseudo’ method accepts all the generated perturbations of an observation resulting in more perturbations compared to ‘pseudo-0.5’ method.

On the other hand, the ‘shuffle’ method just perturbs the variable following its marginal distribution, irrespective of the actual observation. Hence, the perturbation distribution of all 3 observations is identical for the ‘shuffle’ method.

### Local Diagnosis on an Example Dataset

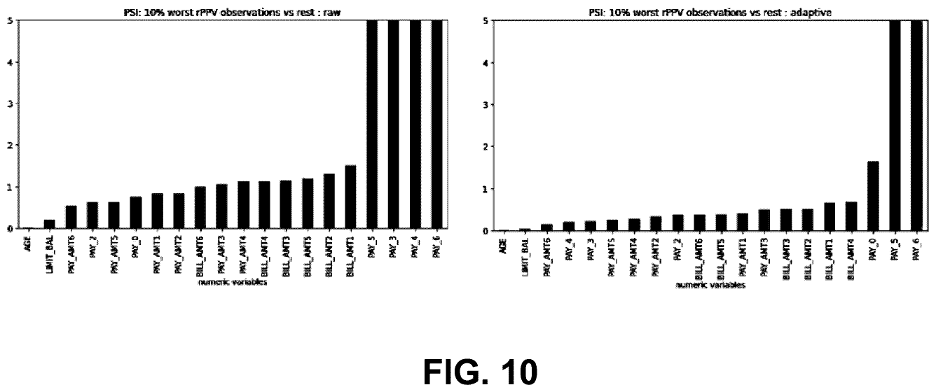

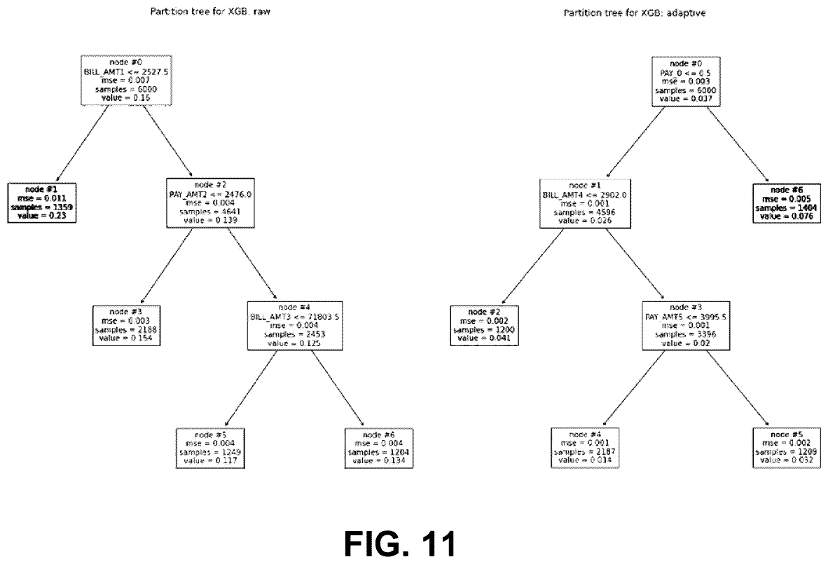

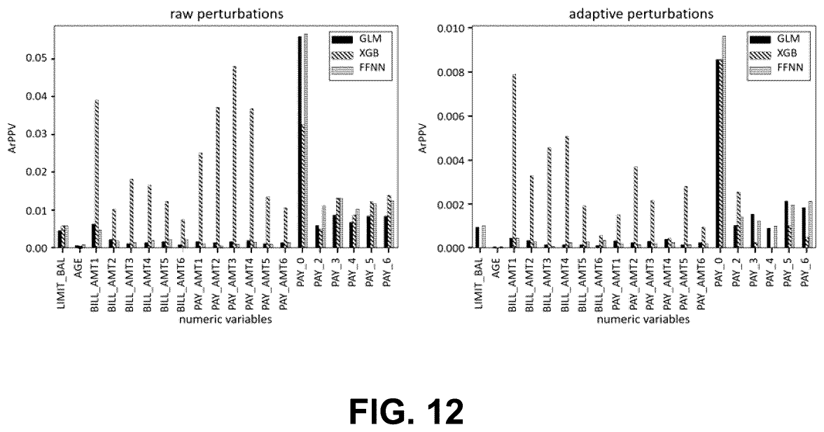

As discussed above in relation to FIG. 5, XGB has the higher volatility at low (<5%) budget for both raw and adaptive perturbations for numeric variables. A local diagnosis (as described above in relation to local diagnosis techniques) is performed to identify the source of this higher volatility in this model. In particular, a local diagnosis is performed on the XGB model to understand its local behavior and identify the regions of data where it is least stable. The local diagnosis is performed for the numeric variables using 2% perturbation budget. The local analysis consists of four parts. Firstly, the PSI (e.g., shown in FIG. 10 where a bar graph of PSI based on observations with worst 10% rPPV for XGB model is shown and where plot 10a is for raw perturbations and plot 10b is for adaptive perturbations) and diagnostic partition tree (e.g., shown in FIG. 11 where plot 11a is for raw perturbations and plot 11b is for adaptive perturbations) analysis is performed for 10% worst observations when simultaneously perturbing all variables. This reveals variables that lead to maximum volatility in the XGB model. Secondly, one variable is perturbed at a time and the ArPPV for all three models (e.g., shown in FIG. 12) is computed, which is used to identify regions where the XGB model shows more volatility for a particular variable compared to other models. Thus, the identified key variables of interest may be further analyzed via a single variable diagnosis method, as described above in relation to the local diagnosis section.

As shown in FIG. 10 and FIG. 11, ‘BILL_AMT1’ is the prime source of volatility at 2% budget for raw perturbation, whereas ‘PAY_0’ is the top variable of interest for adaptive perturbations followed by ‘BILL_AMT4’. The diagnostic trees also split on some of the ‘PAY_AMT’ variables, although they are not the first splits indicating these variables as a source of volatility as well. PSI for some of the PAY variables is infinite, suggesting a difference in support of the distributions of the worst observations vs rest. Note that the PAY, BILL_AMT and PAY_AMT variables are highly correlated and hence they may be associated with a raised PSI due to this correlation or a correlated variable being a proxy for the split on another variable.

The variable-by-variable analysis confirms ‘BILL_AMT1’ as not only a high source of volatility for the XGB model but also a variable where the XGB model's volatility is significantly higher than the other models for both raw and adaptive perturbations. The ‘PAY_AMT’ variables are also identified as sources of added volatility specifically for XGB models and this is supported by their higher variable importance for the XGB model. Among the ‘PAY_AMT’ variables, ‘PAY_AMT2’ ranks high in both raw and adaptive perturbation and is also a split variable for the raw perturbation diagnostic tree in FIG. 11. Thus, a follow-up analysis on the two variables ‘BILL_AMT1’ and ‘PAY_AMT2’ may be performed. The ArPPV for adaptive perturbations in FIG. 12 are much smaller than their raw counterparts.

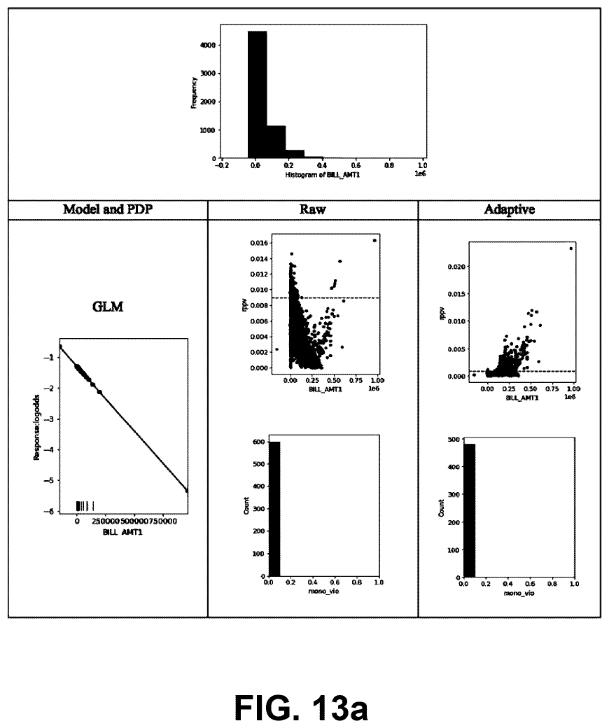

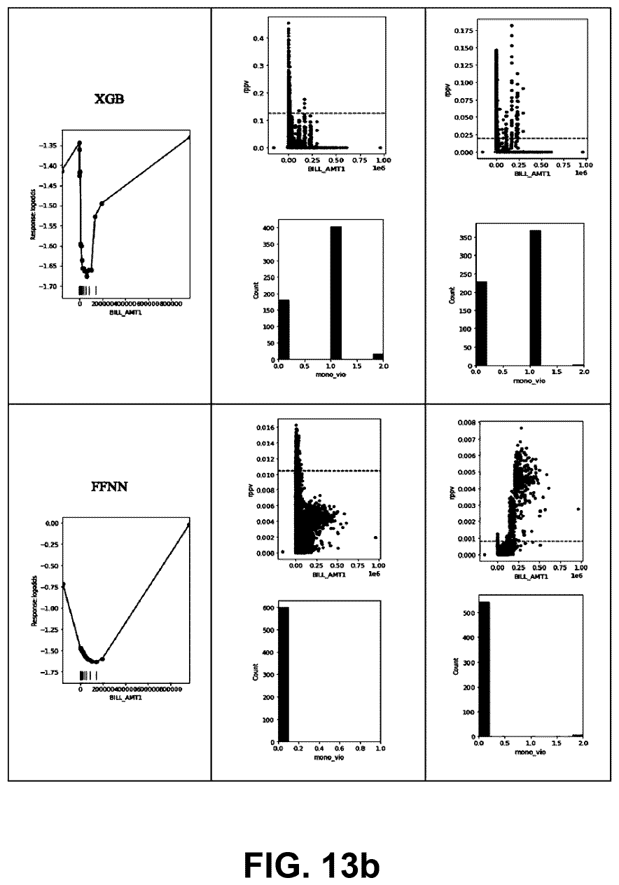

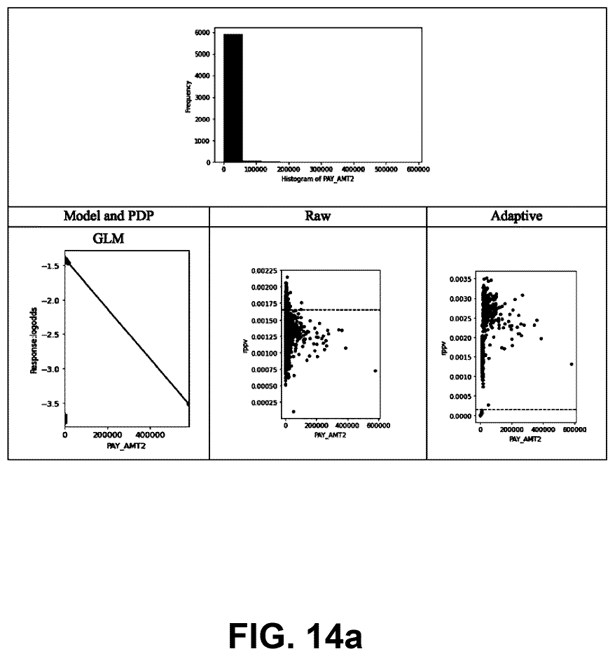

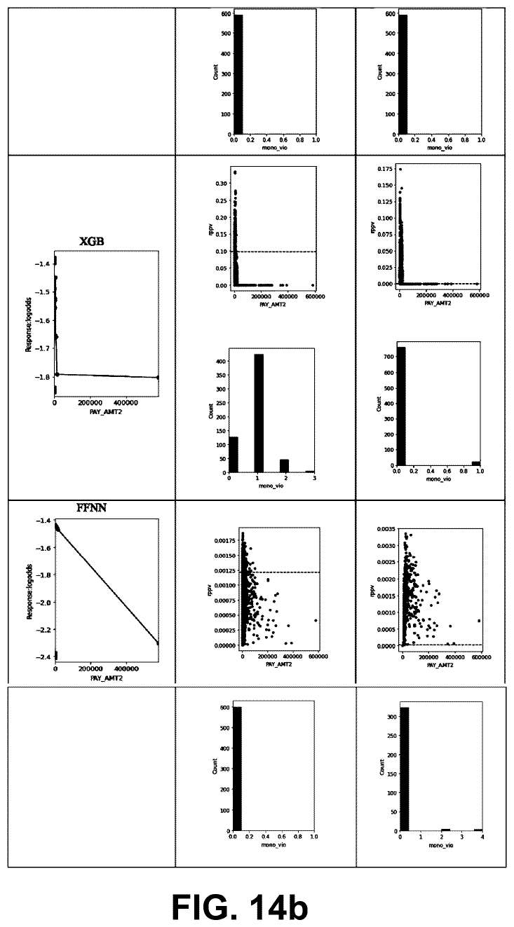

In a follow up diagnosis, the variable of interest is perturbed and the rPPV for each observations with a two percent budget. The results for ‘BILL_AMT1’ are given in FIG. 13a and FIG. 13b and that of ‘PAY_AMT2’ in FIG. 14a and FIG. 14b.

The diagnosis for ‘BILL_AMT1’ shows that XGB model has a more jagged PDP than the other models resulting in a number of monotone violations. Although the FFNN PDP captures similar model behavior, it has a more stable behavior resulting in less (or no) monotone violations. The histogram of ‘BILL_AMT1’ is left skewed with high data concentration on the lower values. The adaptive perturbations thus produce more conservative perturbations in this range. However, even with these smaller perturbations the XGM model is more volatile in this range than the other two models.

The PDP of the XGB model for ‘PAY_AMT2’ once again shows a sharp transition in FIG. 14a-14b, which causes the high rPPV values in this model compared to the others. For the raw perturbations, the high rPPV (>0.1) points also have substantial number of monotone violations showing that the transition is not smooth and the raised rPPV values occur due to a combination of sensitivity and lack of robustness. Under the adaptive perturbations, the perturbation strength in this transition region is lowered, which has significantly reduced the number of monotone violations although the observations in the lower range of this variable still have higher rPPV for XGB model than the other models. Note that FFNN models also show some monotone violations with adaptive perturbations, possibly caused by the higher perturbations in the sparse regions. However, the rPPV for these observations are less than 0.008 and hence these are not strong enough violations to cause concern.

The above-described analysis helped reveal which variables are causing the XGB model to be more volatile than the others at low budget which may account for the slightly higher gap in this model. As seen from the monotone violations, the robustness of the XGB model may be increased by adding some monotonicity constraints if applicable. However, given the overall behavior of the ArPPV curves in FIG. 5 and FIG. 7, XGB is not substantially non-robust to perturbations compared to the other models and has superior performance compared to the other models. On the other hand, FFNN models seem to deteriorate faster to increasing budgets and is specifically sensitive to the non-numeric covariates. Due to these issues, the XGB model is preferred over the FFNN model.

### System Architecture

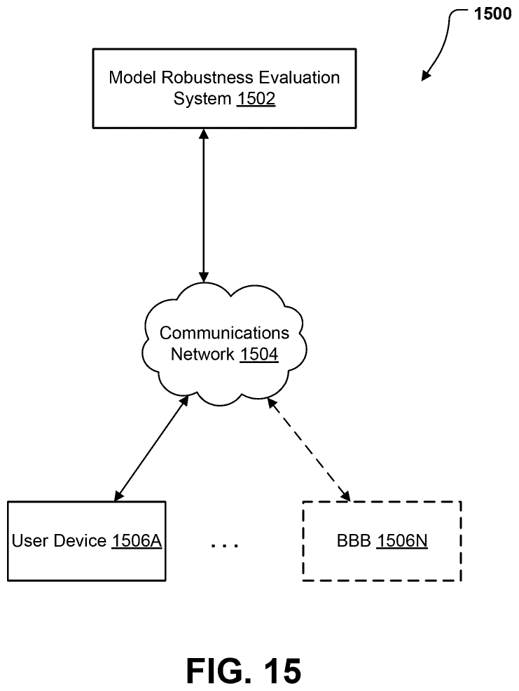

Example embodiments described herein may be implemented using any of a variety of computing devices or servers. To this end, FIG. 15 illustrates an example environment 1500 within which various embodiments may operate. As illustrated, a model robustness evaluation system 1502 may receive and/or transmit information via communications network 1504 (e.g., the Internet) with any number of other devices, such as one or more of user devices 1506A-1506N.

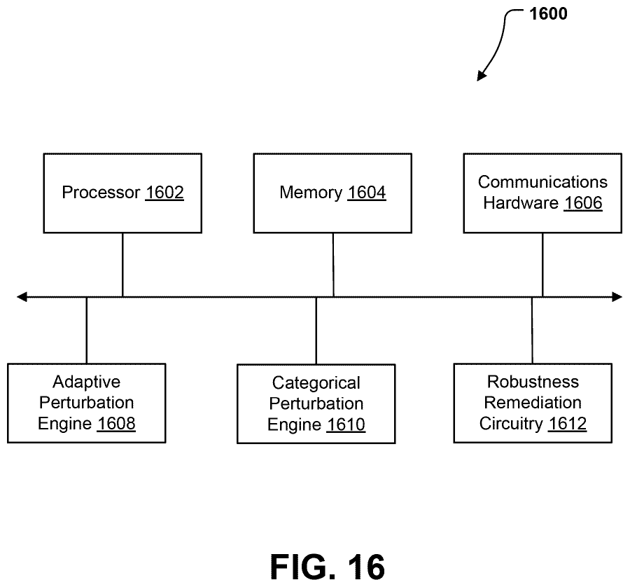

The model robustness evaluation system 1502 may be implemented as one or more computing devices or servers, which may be composed of a series of components. Particular components of the model robustness evaluation system 1502 are described in greater detail below with reference to apparatus 1600 in connection with FIG. 16.

The one or more user devices 1506A-1506N may be embodied by any computing devices known in the art. The one or more user devices may be associated with a user that is associated with an entity that is providing the model robustness evaluation that is provided by model robustness evaluation system 1502. The one or more user devices 1506A-1506N need not themselves be independent devices but may be peripheral devices communicatively coupled to other computing devices.

### Example Implementing Apparatuses

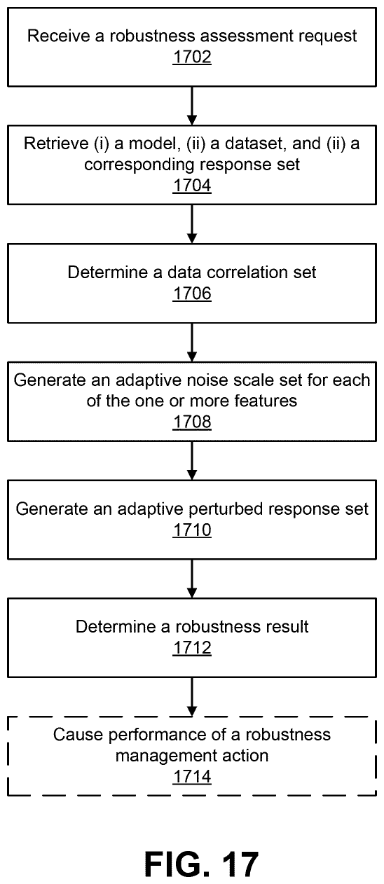

The model robustness evaluation system 1502 (described previously with reference to FIG. 1) may be embodied by one or more computing devices or servers, shown as apparatus 1600 in FIG. 16. The apparatus 1600 may be configured to execute various operations described above in connection with FIG. 15 and below in connection with FIGS. 17-22. As illustrated in FIG. 16, the apparatus 1600 may include processor 1602, memory 1604, communications hardware 1606, adaptive perturbation engine 1608, categorical perturbation engine 1610, and robustness remediation circuitry 1612, each of which will be described in greater detail below.

The processor 1602 (and/or co-processor or any other processor assisting or otherwise associated with the processor) may be in communication with the memory 1604 via a bus for passing information amongst components of the apparatus. The processor 1602 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 1600, remote or “cloud” processors, or any combination thereof.

The processor 1602 may be configured to execute software instructions stored in the memory 1604 or otherwise accessible to the processor. In some cases, the processor may be configured to execute hard-coded functionality. As such, whether configured by hardware or software methods, or by a combination of hardware with software, the processor 1602 represent an entity (e.g., physically embodied in circuitry) capable of performing operations according to various embodiments of the present invention while configured accordingly. Alternatively, as another example, when the processor 1602 is embodied as an executor of software instructions, the software instructions may specifically configure the processor 1602 to perform the algorithms and/or operations described herein when the software instructions are executed.

Memory 1604 is non-transitory and may include, for example, one or more volatile and/or non-volatile memories. In other words, for example, the memory 1604 may be an electronic storage device (e.g., a computer readable storage medium). The memory 1604 may be configured to store information, data, content, applications, software instructions, or the like, for enabling the apparatus to carry out various functions in accordance with example embodiments contemplated herein.

The communications hardware 1606 may be any means such as a device or circuitry embodied in either hardware or a combination of hardware and software that is configured to receive and/or transmit data from/to a network and/or any other device, circuitry, or module in communication with the apparatus 1600. In this regard, the communications hardware 1606 may include, for example, a network interface for enabling communications with a wired or wireless communication network. For example, the communications hardware 1606 may include one or more network interface cards, antennas, buses, switches, routers, modems, and supporting hardware and/or software, or any other device suitable for enabling communications via a network. Furthermore, the communications hardware 1606 may include the processing circuitry for causing transmission of such signals to a network or for handling receipt of signals received from a network.

The communications hardware 1606 may further be configured to provide output to a user and, in some embodiments, to receive an indication of user input. In this regard, the communications hardware 1606 may comprise a user interface, such as a display, and may further comprise the components that govern use of the user interface, such as a web browser, mobile application, dedicated client device, or the like. In some embodiments, the communications hardware 1606 may include a keyboard, a mouse, a touch screen, touch areas, soft keys, a microphone, a speaker, and/or other input/output mechanisms. The communications hardware 1606 may utilize the processor 1602 to control one or more functions of one or more of these user interface elements through software instructions (e.g., application software and/or system software, such as firmware) stored on a memory (e.g., memory 1604) accessible to the processor 1602.

In addition, the apparatus 1600 further comprises an adaptive perturbation engine 1608 that may retrieve (i) a model, (ii) a dataset, and (iii) a corresponding response set. In addition, the adaptive perturbation engine 1608 determines a data correlation set and generate an adaptive noise scale set for each feature included in the dataset. Further, the adaptive perturbation engine generates an adaptive perturbed response set and determines a robustness result. In some embodiments, adaptive perturbation engine 1608 may leverage a variety of models to perform the above operations. The adaptive perturbation engine 1608 may utilize processor 1602, memory 1604, or any other hardware component included in the apparatus 1600 to perform these operations, as described in connection with FIGS. 4-6 below. The adaptive perturbation engine 1608 may further utilize communications hardware 1606 to gather data from a variety of sources (e.g., user device 1506A through user device 1506N, as shown in FIG. 1), and/or exchange data with a user, and in some embodiments may utilize processor 1602 and/or memory 1604.

In addition, the apparatus 1600 further comprises a categorical perturbation engine 1610 that may retrieve (i) a model, (ii) a dataset, and (iii) a corresponding response set. In addition, the categorical perturbation engine 1610 determines a categorical observation set and determines a categorical observation subset. Further, the categorical perturbation engine 1610 generates a perturbed response set and determines a robustness result. In some embodiments, the categorical perturbation engine 1610 may leverage a variety of models to perform the above operations. The categorical perturbation engine 1610 may utilize processor 1602, memory 1604, or any other hardware component included in the apparatus 1600 to perform these operations, as described in connection with FIGS. 7-9 below. The categorical perturbation engine 1610 may further utilize communications hardware 1606 to gather data from a variety of sources (e.g., user device 1506A through user device 1506N, as shown in FIG. 1), and/or exchange data with a user, and in some embodiments may utilize processor 1602 and/or memory 1604.

Further, the apparatus 1600 further comprises a robustness remediation circuitry 1612 that causes performance of a robustness remediation action. The robustness remediation circuitry 1612 may utilize processor 1602, memory 1604, or any other hardware component included in the apparatus 1600 to perform these operations, as described in connection with FIG. 4 and FIG. 7 below. The robustness remediation circuitry 1612 may further utilize communications hardware 1606 to gather data from a variety of sources (e.g., user device 1506A through user device 1506N, as shown in FIG. 1), and/or exchange data with a user, and in some embodiments may utilize processor 1602 and/or memory 1604.

Although components 1602-1612 are described in part using functional language, it will be understood that the particular implementations necessarily include the use of particular hardware. It should also be understood that certain of these components 1602-1612 may include similar or common hardware. For example, the adaptive perturbation engine 1608, categorical perturbation engine 1610, and robustness remediation circuitry 1612 may each at times leverage use of the processor 1602, memory 1604, or communications hardware 1606, such that duplicate hardware is not required to facilitate operation of these physical elements of the apparatus 1600 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 1600 to perform the various functions described herein.

Although the adaptive perturbation engine 1608, categorical perturbation engine 1610, and robustness remediation circuitry 1612 may leverage processor 1602, memory 1604, or communications hardware 1606 as described above, it will be understood that any of adaptive perturbation engine 1608, categorical perturbation engine 1610, and robustness remediation circuitry 1612 may include one or more dedicated processor, specially configured field programmable gate array (FPGA), or application specific interface circuit (ASIC) to perform its corresponding functions, and may accordingly leverage processor 1602 executing software stored in a memory (e.g., memory 1604), or communications hardware 1606 for enabling any functions not performed by special-purpose hardware. In all embodiments, however, it will be understood that adaptive perturbation engine 1608, categorical perturbation engine 1610, and robustness remediation circuitry 1612 comprise particular machinery designed for performing the functions described herein in connection with such elements of apparatus 1600.

In some embodiments, various components of the apparatus 1600 may be hosted remotely (e.g., by one or more cloud servers) and thus need not physically reside on the corresponding apparatus 1600. For instance, some components of the apparatus 1600 may not be physically proximate to the other components of apparatus 1600. Similarly, some or all of the functionality described herein may be provided by third party circuitry. For example, a given apparatus 1600 may access one or more third party circuitries in place of local circuitries for performing certain functions.

As will be appreciated based on this disclosure, example embodiments contemplated herein may be implemented by an apparatus 1600. Furthermore, some example embodiments may take the form of a computer program product comprising software instructions stored on at least one non-transitory computer-readable storage medium (e.g., memory 1604). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 1600 as described in FIG. 16, that loading the software instructions onto a computing device or apparatus produces a special-purpose machine comprising the means for implementing various functions described herein.

Having described specific components of example apparatuses 1600, example embodiments are described below in connection with a series of flowcharts.

### Example Operations

Turning to FIGS. 17-22, example flowcharts are illustrated that contain example operations implemented by example embodiments described herein. The operations illustrated in FIGS. 17-22 may, for example, be performed by model robustness evaluation system 1502 shown in FIG. 15, which may in turn be embodied by an apparatus 1600, which is shown and described in connection with FIG. 16. To perform the operations described below, the apparatus 1600 may utilize one or more of processor 1602, memory 1604, communications hardware 1606, adaptive perturbation engine 1608, categorical perturbation engine 1610, and robustness remediation circuitry 1612, and/or any combination thereof. It will be understood that user interaction with the model robustness evaluation system 1502 may be facilitated by a computing device, such as user device 1506A, as shown in FIG. 15.

### Example Operations for Dynamic Model Robustness Evaluation

Turning first to FIG. 17, example operations are shown for dynamic model robustness evaluation.

As shown by operation 1702, the apparatus 1600 includes means, such as memory 1604, communications hardware 1606, or the like, for receiving a robustness assessment request. A robustness assessment request may be an electronic request that comprises a plurality of assessment parameters that may be utilized to perform a particular model robustness assessment. For example, the plurality of assessment parameters may include a budget (e.g., b) that defines the strength of the perturbations, a k-value that defines the number of perturbations to perform, a model identifier (e.g., a model name, a model ID, or the like) that identifies a particular model for robustness evaluation, a dataset (e.g., a training dataset that the identified model used for training), and/or the like.

In some embodiments, the apparatus 1600 may receive a robustness assessment request from a computing device associated with a user (e.g., an individual associated with an entity, such as a company, government agency, university, or the like). For example, communications hardware 1606 may receive the robustness assessment request from user device 1506A via a network (e.g., communications network 1504, shown in FIG. 1). In some embodiments, upon receiving the robustness assessment request, the robustness assessment request may be stored in a local storage device (e.g., memory 1604, or the like). Additionally, the apparatus 1600 (e.g., adaptive perturbation engine 1608, categorical perturbation engine 1610, or the like) may utilize any suitable technique (e.g., Natural Language Processing (NLP)) to determine the plurality of assessment parameters from the received robustness assessment request. In such an embodiment, adaptive perturbation engine 1608 may store the plurality of assessment parameters in a local storage device, such as memory 1604.

As shown by operation 1704, the apparatus 1600 includes means, such as memory 1604, adaptive perturbation engine 1608, or the like, for retrieving (i) a model, (ii) a dataset, and (iii) a corresponding response set. The model may be a machine learning model (e.g., a decision tree, logistic regression model, and/or the like) that was trained using the dataset (e.g., a training dataset a holdout set, or the like) to learn patterns and make predictions based one or more input features. The dataset may be a data structure that includes a plurality of observations (e.g., a collection of labeled observations) where each observation consists of one or more features (e.g., covariates) and a corresponding output (e.g., a classification label). The input features may be associated with numeric values or categorical values. The corresponding response set may be a data structure that includes a collection of ground truth responses associated with the dataset. In some embodiments, if ground truth responses for a dataset are not available, the corresponding response set may correspond to the responses generated by the retrieved machine learning model given a particular input (e.g., the retrieved dataset).

In some embodiments, the (i) model, (ii) dataset, and/or (iii) corresponding response set may be stored in a local storage device (e.g., memory 1604, or the like). Moreover, the corresponding response set and/or dataset may be stored in the form of key-value pairs where the key is an indication of the model (e.g., a model ID associated with the model), and the value is the dataset and/or corresponding response set.

In some embodiments, to retrieve the (i) model, (ii) dataset, and/or (iii) corresponding response set, adaptive perturbation engine 1608 may retrieve the plurality of assessment parameters from a local storage device (e.g., memory 1604) and subsequently utilize the plurality of assessment parameters to select and ultimately retrieve the model, data set, and corresponding response set. For example, a plurality of models, datasets, and corresponding response sets may be stored in a local storage device. The plurality of models may each be associated with a unique model ID. As such, adaptive perturbation engine 1608 may utilize a parameter (e.g., a parameter of the plurality of assessment parameters) that includes a model ID that was included in the robustness assessment request to retrieve a model that is associated with the model ID. By means of continuing example, adaptive perturbation engine 1608 may subsequently use the model ID as a key in a key-value pair to retrieve a corresponding dataset and/or corresponding response set from a local storage device.

As shown by operation 1706, the apparatus 1600 includes means, such as memory 1604, adaptive perturbation engine 1608, or the like, for determining a data correlation set. A data correlation set may be a data structure that comprises data elements that describes the relationships between variables included in the dataset. In some embodiments, the correlation dataset may be a Pearson correlation data structure (\hat{P}) for the dataset. In this regard, adaptive perturbation engine 1608 may use any suitable method known in the art to determine a Pearson correlation structure for the retrieved dataset. Subsequently, adaptive perturbation engine 1608 may store the Pearson correlation structure (e.g., the data correlation set) in a local storage device, such as memory 1604.

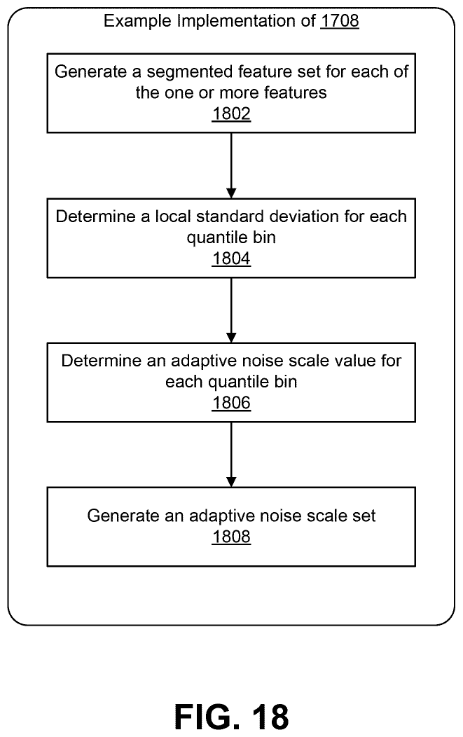

As shown by operation 1708, the apparatus 1600 includes means, such as memory 1604, adaptive perturbation engine 1608, or the like, for generating an adaptive noise scale set for each observation of the plurality of observations. The adaptive noise scale set may be a data structure (e.g., \tilde{σ}ᵢⱼ, as discussed above in relation to adaptive perturbations) that may include values that may scale each observation ‘i’ based on a spread of nearby points. In some embodiments, adaptive perturbation engine 1608 may utilize equation 7 to determine an adaptive noise scale set for each observation of the plurality of observations in accordance with the description provided above for adaptive perturbations. In some embodiments, adaptive perturbation engine 1608 may store the generated adaptive noise scale set in a local storage device, such as memory 1604. Since the adaptive perturbation technique utilizes an adaptive noise scale set for generating perturbations, the adaptive perturbation technique accounts for local variation in the dataset. As such, adaptive perturbation engine 1608 may adjust equation 3 by substituting the noise scale σⱼ to σᵢⱼ, which allows for each observation ‘i’ to be scaled based on the spread of nearby points. The generation of an adaptive noise scale set is described in greater detail below in relation to FIG. 18.

Turning now to FIG. 18, example operations are shown for determining generating an adaptive noise scale set.

As shown by operation 1802, the apparatus 1600 includes means, such as memory 1604, adaptive perturbation engine 1608, or the like, for generating a segmented feature set for each of the one or more features. The segmented feature set may be a data structure that buckets each variable into quantile bins (e.g., dividing the data for a particular feature into equal-sized bins). In some embodiments, adaptive perturbation engine 1608 may retrieve the dataset from a local storage device (e.g., memory 1604) and subsequently may generate a segmented feature set for each of the one or more features included in the dataset.

As shown by operation 1804, the apparatus 1600 includes means, such as memory 1604, adaptive perturbation engine 1608, or the like, for determining a local standard deviation for each quantile bin. To do so, adaptive perturbation engine 1608 may retrieve a segmented feature set from a local storage device (e.g., memory 1604, or the like) and subsequently calculate the standard deviation for each quantile bin (e.g., referred to as s_{q} as described above in relation to adaptive perturbations). In some embodiments, adaptive perturbation engine 1608 may store the local standard deviation for each quantile bin in memory 1604.

As shown by operation 1806, the apparatus 1600 includes means, such as adaptive perturbation engine 1608, or the like, for determining an adaptive noise scale value for each quantile bin. The adaptive noise scale value (e.g., a particular \tilde{σ}ᵢⱼ in equation 7) may be determined for each observation i and each feature j included in the dataset. In some embodiments, adaptive perturbation engine 1608 may use equation 7 to determine the adaptive noise scale value for each quantile bin.

As shown by operation 1808, the apparatus 1600 includes means, such as memory 1604, adaptive perturbation engine 1608, or the like, for generating an adaptive noise scale set. In some embodiments, adaptive perturbation engine 1608 may generate an adaptive noise scale set that store all determined adaptive noise scale values. In this regard, the adaptive noise scale set may be a data structure that may be used (described in more detail below) to scale each observation ‘i’ based on a spread of nearby points. In some embodiments, the adaptive noise scale set may include the adaptive noise scale values for each observation/feature included in the dataset and that are generated in accordance with the description provided above for operation 1806.

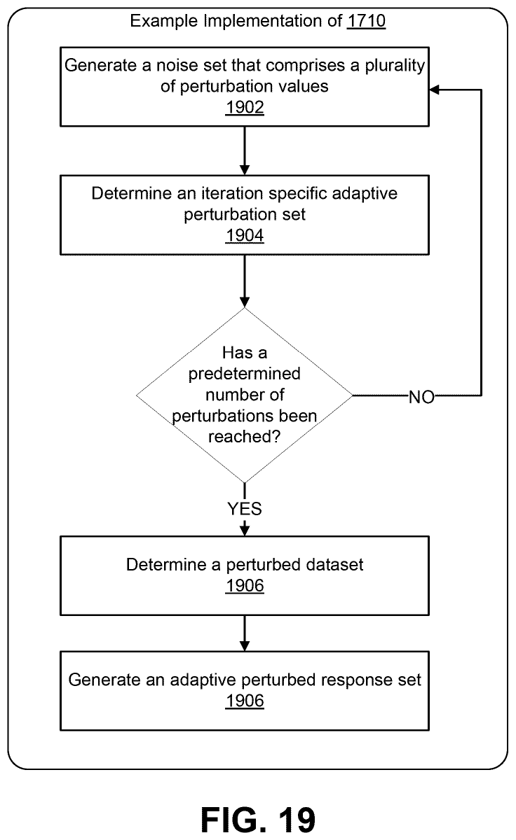

Returning to FIG. 17, as shown by operation 1710, apparatus 1600 includes means, such as memory 1604, adaptive perturbation engine 1608, or the like, for generating an adaptive perturbed response set. The adaptive perturbed response set may be a data structure that comprises model generated responses that are generated in response to providing a perturbed response set (e.g., a data structure comprising K perturbations to the retrieved dataset) to the retrieved model that is being evaluated by the apparatus 1600. In some embodiments, adaptive perturbation engine 1608 may utilize the data correlation set, a budget (e.g., a predefined measure of locality), a predefined number of perturbations (e.g., a k value), and the adaptive noise set, to generate the adaptive perturbed response set. In some embodiments, the predefined budget and/or predefined number of perturbations may be predefined by the entity that is providing the model robustness evaluation provided by the apparatus 1600. The generation of an adaptive perturbed response set is described in further detail below in relation to FIG. 19.

Turning now to FIG. 19, example operations are shown for generating an adaptive perturbed response set.

As shown by operation 1902, apparatus 1600 includes means, such as memory 1604, adaptive perturbation engine 1608, or the like, for generating a noise set that comprises a plurality of perturbation values. In some embodiments, adaptive perturbation engine 1608 may generate a noise set by using equation 5 where ∈ᵢₖ is the generated noise for a particular observation (e.g., observation i) and particular perturbation number (e.g., perturbation number k). In some embodiments, the noise values included in the noise set may be generated from a Gaussian distribution whose correlation structure is taken from the original data (e.g., via the data correlation set).

As shown by operation 1904, apparatus 1600 includes means, such as memory 1604, adaptive perturbation engine 1608, or the like, for generating an iteration specific adaptive perturbation set. The iteration specific adaptive perturbation set may be a data structure that includes perturbed values for each observation included in the dataset for a particular perturbation iteration. For example, adaptive perturbation engine 1608 may generate an iteration specific adaptive perturbation set that includes a perturbation value for each value included in the dataset. In this regard, adaptive perturbation engine 1608 may utilize equation 3 to calculate a perturbation value for each data element included in the dataset. In some embodiments, the adaptive perturbation engine 1608 may store each specific iteration specific adaptive perturbation set in memory 1604. If the predetermined number of iterations has not been reached, the procedure may revert to operation 1902 to allow for the adaptive perturbation engine 1608 to generate a new noise set and subsequently generate a new iteration specific adaptive perturbation set that may also in turn be stored in memory 1604. If the predetermined number of iterations has been reached, the procedure may advance to operation 1906.

As shown by operation 1906, apparatus 1600 includes means, such as processor 1602, memory 1604, adaptive perturbation engine 1608, or the like, for determining a perturbed dataset. The perturbed dataset may be a data structure that includes the summation of each iteration specific adaptive perturbation set that was generated in accordance with operation 1904. In some embodiments, adaptive perturbation engine 1608 may determine a perturbed dataset by using equation 6. For example, assume the predefined number of perturbations is k. As such, the adaptive perturbation engine 1608 may sum all k iteration specific adaptive perturbation sets to determine a Δxᵢₖ and then subsequently add the determined Δxᵢₖ to the original dataset.

As shown by operation 1908, apparatus 1600 includes means, such as memory 1604, adaptive perturbation engine 1608, or the like, for generating an adaptive perturbed response set. The adaptive perturbed response set may refer to a data construct that stores the values corresponding to an input perturbed dataset. In some embodiments, adaptive perturbation engine 1608 may generate an adaptive perturbed response set by providing the determined perturbed dataset to the retrieved model (which may output the perturbed response set). Thereafter, the adaptive perturbation engine 1608 may store the generated adaptive perturbed response set (that was generated by the model) in a local storage device (e.g., memory 1604).

Returning to FIG. 7, as shown by operation 1712, apparatus 1600 includes means, such as memory 1604, adaptive perturbation engine 1608, or the like, for determining a robustness result. The robustness result may indicate whether a model is robust or not robust based on a robustness measure, such as rPPV, ArPPV, or the like. For example, the robustness result may be a categorical value of “robust” or “not robust”, a numerical value of 1 for a model that is robust and numerical value of 0 for a model that is not robust, a Boolean value of “true” for a robust model or “false” for a model that is not robust. In some embodiments, adaptive perturbation engine 1608 may retrieve a determined adaptive perturbed response set and the corresponding response set from a local storage device, such as memory 1604, and subsequently utilized the corresponding response set and perturbed response set to determine an ArPPV value (e.g., by using equation 1 and equation 2). Thereafter, adaptive perturbation engine 1608 may compare the ArPPV value to a predefined robustness threshold to determine whether the model corresponds to a robust or not robust model. For example, if the ArPPV value satisfies the predefined robustness threshold, adaptive perturbation engine 1608 may determine a “not robust” robustness result. Alternatively, if the ArPPV value does not satisfy the predefined robustness threshold, adaptive perturbation engine 1608 may determine a “robust” robustness result.

As shown by operation 1714, apparatus 1600 includes means, such as processor 1602, memory 1604, robustness remediation circuitry 1612, or the like, for causing performance of a robustness management action. The robustness management action may correspond to a local diagnosis approach that may be performed by the apparatus 1600 (e.g., robustness remediation circuitry 1612, or the like) to identify regions of the data where a model shows a lack of robustness.

In some embodiments, the apparatus 1600 (e.g., robustness remediation circuitry 1612) may use a PSI identify the one or more features a model that shows a lack of robustness. To do so, the apparatus may generate an observation subset. The observation subset may include one or more observations from the perturbed response set. For example, robustness remediation circuitry 1612 may determine whether the rPPV for a particular observation satisfies a rPPV threshold (e.g., a threshold predefined by the entity that is providing the local diagnosis provided by the apparatus 1600). Thereafter, the robustness remediation circuitry 1612 may use the difference between the subset of observations with the highest rPPV and the rest of the observations for each variable. The robustness remediation circuitry 1612 may then rank the variables by their corresponding PSI. Thus, the robustness remediation circuitry 1612 may identify the set of variables that display maximum shift in distribution based on their respective PSI.

In some embodiments, the apparatus 1600 (e.g., robustness remediation circuitry 1612) may use a supervised partitioning tree to identify the one or more features a model that shows a lack of robustness. To do so, the robustness remediation circuitry 1612 may create a diagnostic supervised partition tree on the covariate space using each observation's rPPV as the response. As such, at each leaf node, the robustness remediation circuitry 1612 may obtain the average rPPV for observations in that node. Robustness remediation circuitry 1612 may identify variables of interest as those that have resulted in a node split, and particularly the nodes that result in the maximum difference between the average rPPV values of its leaf nodes. The robustness remediation circuitry 1612 may then use these set of variables to identify high volatility regions (e.g., regions that lack robustness) in the dataset and diagnosing these variables may further help reveal the causes of the volatility in the predictions of the given model.

### Example Operations for Perturbing Categorical Variables to Evaluate Model Robustness

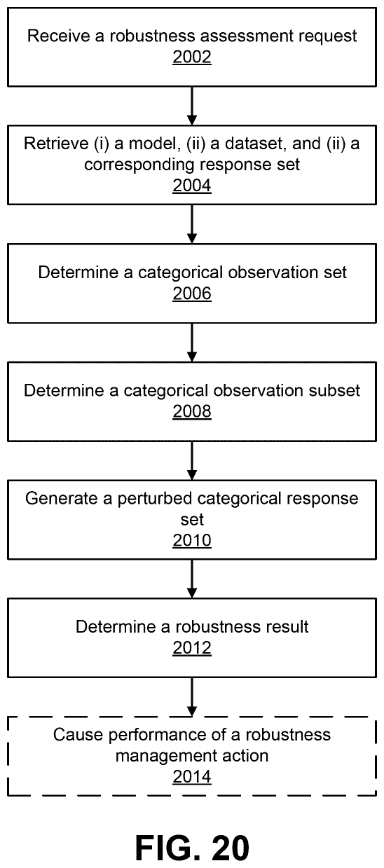

Turning now to FIG. 20, example operations are shown for perturbing categorical variables to evaluate model robustness.

As shown by operation 2002, the apparatus 1600 includes means, such as memory 1604, communications hardware 1606, or the like, for receiving a robustness assessment request. A robustness assessment request may be an electronic request that comprises a plurality of assessment parameters that may be utilized to perform a particular model robustness assessment. For example, the plurality of assessment parameters may include a budget that defines the strength of the perturbations, a k-value that defines the number of perturbations to perform, a model identifier (e.g., a model name, a model ID, or the like) that identifies a particular model for evaluation, a dataset (e.g., a training dataset that the identified model used for training), or the like.

In some embodiments, the apparatus 1600 may receive a robustness assessment request from a computing device associated with a user (e.g., an individual associated with an entity, such as a company, government agency, university, or the like). For example, communications hardware 1606 may receive the robustness assessment request from user device 1506A via a network (e.g., communications network 1504, shown in FIG. 1). In some embodiments, upon receiving the robustness assessment request, the robustness assessment request may be stored in a local storage device (e.g., memory 1604, or the like). Additionally, the apparatus 1600 (e.g., adaptive perturbation engine 1608, categorical perturbation engine 1610, or the like) may utilize any suitable technique (e.g., Natural Language Processing (NLP)) to determine the plurality of assessment parameters from the received robustness assessment request. In such an embodiment, the plurality of assessment parameters may be stored in a local storage device, such as memory 1604.

As shown by operation 2004, the apparatus 1600 includes means, such as processor 1602, memory 1604, categorical perturbation engine 1610, or the like, for retrieving (i) a model, (ii) a dataset, and (iii) a corresponding response set. The model may be a machine learning model (e.g., a decision tree, logistic regression model, and/or the like) that was trained using the dataset (e.g., a training dataset) to learn patterns and make predictions based one or more input features that are included in a dataset. The dataset may be a data structure that includes a plurality of observations (e.g., a collection of labeled observations) where each observation consists of one or more features (e.g., covariates) and a corresponding output (e.g., a classification label). The input features may be associated with numeric values or categorical values. The corresponding response set may be a data structure that includes a collection of ground truth responses associated with the dataset. In some embodiments, if ground truth responses for a dataset are not available, the corresponding response set may correspond to the responses generated by the retrieved machine learning model given a particular input (e.g., the retrieved dataset).

In some embodiments, the (i) model, (ii) dataset, and/or (iii) corresponding response set may be stored in a local storage device (e.g., memory 1604, or the like). Moreover, the corresponding response set and/or dataset may be stored in the form of key-value pairs where the key is the model (e.g., a model ID associated with the model) is the key and the value is the dataset and/or corresponding response set.

In some embodiments, to retrieve the (i) model, (ii) dataset, and/or (iii) corresponding response set, categorical perturbation engine 1610 may retrieve the plurality of assessment parameters from a local storage device (e.g., memory 1604) and subsequently utilize the plurality of assessment parameters to select and ultimately retrieve the model, data set, and corresponding response set. For example, a plurality of models, datasets, and corresponding response sets may be stored in a local storage device. The plurality of models may each be associated with a unique model ID. As such, categorical perturbation engine 1610 may utilize a parameter (e.g., a parameter of the plurality of assessment parameters) that includes a model ID that was included in the robustness assessment request to retrieve a model that is associated with the model ID. By means of continuing example, categorical perturbation engine 1610 may subsequently use the model ID as a key in a key-value pair to retrieve a corresponding dataset and/or corresponding response set from a local storage device.

As shown by operation 2006, the apparatus 1600 includes means, such as memory 1604, categorical perturbation engine 1610, or the like, for determining a categorical observation set. The categorical observation set may be a data structure that includes the set of combinations of categorical observations present in the training data. In some embodiments, the categorical observation set may be defined as X, as mentioned above in relation to a categorical perturbation strategy. In this regard, categorical perturbation engine 1610 may utilize any suitable technique to identify the set of combinations of categorical observations in the training data and subsequently determine the categorical observation set. In some embodiments, the categorical perturbation engine 1610 may then store the determined categorical observation set in a local storage device (e.g., memory 1604).

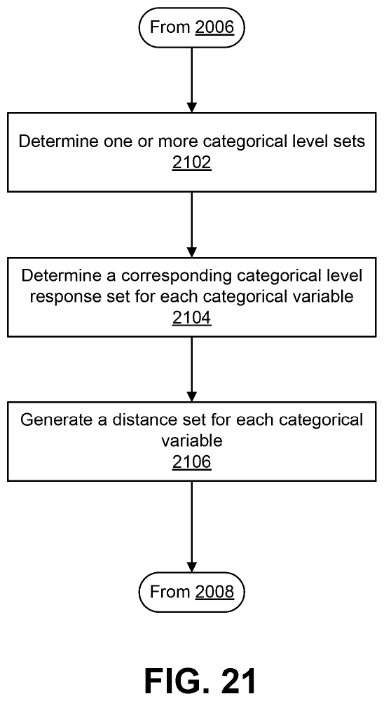

Turning now to FIG. 21, example operations are shown for generating a distance set.

As shown by operation 2102, the apparatus 1600 includes means, such as categorical perturbation engine 1610, or the like, for determining one or more categorical level sets. A categorical level set may be a data structure that includes the levels associated with a particular categorical variable. For example, the categorical level set for a categorical variable, such as weather may include levels including, but not limited to, sunny, rainy, foggy, overcast, snowy, or the like. In some embodiments, categorical perturbation engine 1610 may determine a categorical level set for each categorical variable included in the dataset in accordance with the above description pertaining to the pseudo distance measure.

As shown by operation 2104, the apparatus 1600 includes means, such as categorical perturbation engine 1610, or the like, for determining a corresponding categorical level response set for each categorical variable. The level response set may include the absolute difference in average response of observations at two different levels included in a categorical level set.

Categorical perturbation engine 1610 may generate the categorical level set by using equation 8 in accordance with the description of equation 8 provided above in relation to the pseudo distance measure.

As shown by operation 2106, the apparatus 1600 includes means, such as memory 1604, categorical perturbation engine 1610, or the like, for generating a distance set for each categorical variable. The distance set may be a data construct that comprises distance values that describe the distance between two observations, such as x and x′ on p categorical variables. In some embodiments, categorical perturbation engine 1610 may generate the distance set by using equation 9 in accordance with the description of equation 9 provided above in relation to the pseudo distance measure.

In some embodiments, categorical perturbation engine 1610 may be instructed (e.g., via a model assessment request) to weigh particular variables accordingly to make particular variables (e.g., categorical variables) easier or more difficult to perturb. In such an embodiment, categorical perturbation engine 1610 may use equation 10 in accordance with the description of equation 9 provided above in relation to the pseudo distance measure to determine a weighted distance set. Upon generating the distance set, categorical perturbation engine 1610 may store the generated distance set (or weighted distance set) in a local storage device, such as memory 1604.

Returning to FIG. 20, as shown by operation 2008, the apparatus 1600 includes means, such as memory 1604, categorical perturbation engine 1610, or the like, for determining a categorical observation subset. The categorical observation subset may be a subset of X that consists of combinations that include combinations of categorical variables that are similar to an observation x when measured with a particular pseudo distance measure D. As such, the categorical observation subset may be determined using equation 11 and in accordance with the description provided above in relation to the categorical perturbation strategy. Upon generating the categorical observation subset, categorical perturbation engine 1610 may store the categorical observation subset in a local storage device (e.g., memory 1604).

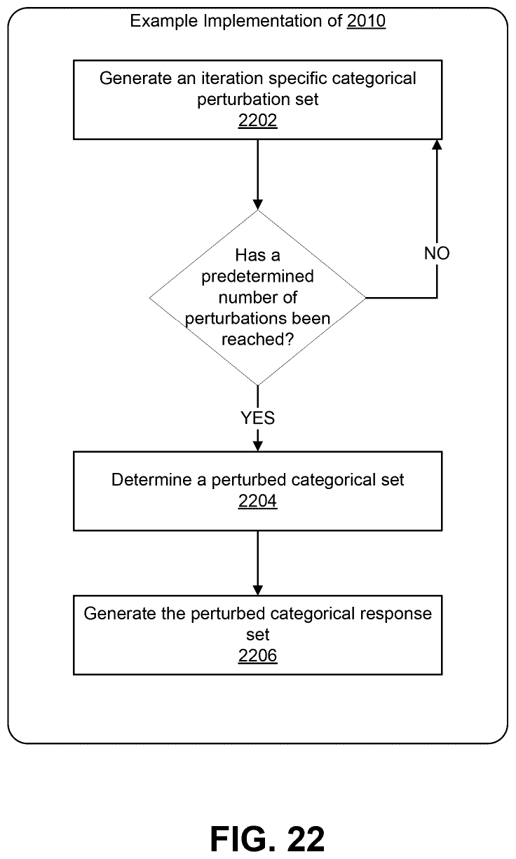

As shown by operation 2010, the apparatus 1600 includes means, such as memory 1604, categorical perturbation engine 1610, or the like, for generating a perturbed response set. The perturbed response set may be a data structure that includes the perturbed responses that are generated in response to providing a perturbed categorical dataset to the model (e.g., the model retrieved in operation 2004). In this regard, the categorical perturbation engine 1610 may provide the model (e.g., the retrieved model) a perturbed categorical set to generate the perturbed response set. This operation is described in greater detail below in relation to FIG. 22. Turning now to FIG. 22, example operations are shown for generating the perturbed response set.

As shown by operation 2202, the apparatus 1600 includes means, such as memory 1604, categorical perturbation engine 1610, or the like, for generating an iteration specific categorical perturbation set. The iteration specific categorical perturbation set may be a data structure that includes perturbed values for each observation included in the dataset for a particular perturbation iteration. For example, categorical perturbation engine 1610 may generate an iteration specific categorical perturbation subset by sampling with replacement from the categorical observation subset. In some embodiments, each sampling may be accepted based on a predefined probability (e.g., predefined by the entity that is providing the categorical perturbations). For example, each perturbation may be accepted based on a probability max_prop. As such, max_prop indicates the proportion of K perturbations to be accepted for each observation. In some embodiments, the categorical perturbation engine 1610 may determine whether a predetermined number of perturbation iterations has been satisfied. If the categorical perturbation engine 1610 determines that a predetermined number of perturbations has not been reached, the procedure may revert back to operation 2202 to generate an iteration specific categorical perturbation set that is based on the previous iterations generated iteration specific categorical perturbation set. Alternatively, if the categorical perturbation engine 1610 determines that a predetermined number of perturbations has been reached, the procedure may advance to operation 2204.

As shown by operation 2204, the apparatus 1600 includes means, such as categorical perturbation engine 1610, or the like, for determining a perturbed categorical set. The perturbed categorical set may be a data structure that includes K perturbed versions of each observation x. In some embodiments, categorical perturbation engine 1610 may sample with replacement K times (e.g., if a predefined number of iterations defined by the entity providing the categorical perturbations is equal to K). As such, the perturbed categorical set may be generated based on all iteration specific categorical perturbation sets. Following the K replacements, categorical perturbation engine 1610 may determine a perturbed categorical dataset based on the K replacements in accordance with the description above pertaining to the categorical perturbation strategy.

As shown by operation 2206, the apparatus 1600 includes means, such as memory 1604, categorical perturbation engine 1610, or the like, for generating the perturbed response set. The perturbed response set may refer to a data construct that stores the values produced by a model in response to providing a perturbed dataset (e.g., the perturbed categorical set) to the model. In this regard, categorical perturbation engine 1610 may generate a perturbed response set by providing the perturbed categorical set to the retrieved model. Thereafter, categorical perturbation engine 1610 may store the perturbed response set in a local storage device, such as memory 1604, or the like.

Returning to FIG. 20, as shown by operation 2012, the apparatus 1600 includes means, such as memory 1604, categorical perturbation engine 1610, or the like, for determining a robustness result. The robustness result may indicate whether a model is robust or not robust based on a robustness measure, such as rPPV, ArPPV, or the like. For example, the robustness result may be a categorical value of “robust” or “not robust”, a numerical value of 1 for a model that is robust and numerical value of 0 for a model that is not robust, a Boolean value of “true” for a robust model or “false” for a model that is not robust. In some embodiments, categorical perturbation engine 1610 may retrieve a determined adaptive perturbed response set and the corresponding response set from a local storage device, such as memory 1604, and subsequently utilized the corresponding response set and perturbed response set to determine an ArPPV value (e.g., by using equation 1 and equation 2). Thereafter, categorical perturbation engine 1610 may compare the ArPPV value to a predefined robustness threshold to determine whether the model corresponds to a robust or not robust model. For example, if the ArPPV value satisfies the predefined robustness threshold, categorical perturbation engine 1610 may determine a “not robust” robustness result. Alternatively, if the ArPPV value does not satisfy the predefined robustness threshold, categorical perturbation engine 1610 may determine a “robust” robustness result.

As shown by operation 2014, the apparatus 1600 includes means, such as memory 1604, robustness remediation circuitry 1612, or the like, for causing performance of a robustness management action. The robustness management action may correspond to a local diagnosis approach that may be performed by the apparatus 1600 (e.g., robustness remediation circuitry 1612, or the like) to identify regions of the data where a model shows a lack of robustness.

In some embodiments, the apparatus 1600 (e.g., adaptive perturbation engine 1608, categorical perturbation engine 1610, or the like) may use a PSI identify the one or more features a model that shows a lack of robustness. To do so, the robustness remediation circuitry 1612 may generate an observation subset. The observation subset may include one or more observations from the perturbed response set. For example, robustness remediation circuitry 1612 may determine whether the rPPV for a particular observation satisfies a rPPV threshold (e.g., a threshold predefined by the entity that is providing the local diagnosis provided by the apparatus 1600). Thereafter, the robustness remediation circuitry 1612 may use the difference between the subset of observations with the highest rPPV and the rest of the observations for each variable. The robustness remediation circuitry 1612 may then rank the variables by their corresponding PSI. Thus, the robustness remediation circuitry 1612 may identify the set of variables that display maximum shift in distribution based on their respective PSI.

In some embodiments, the apparatus 1600 (e.g., robustness remediation circuitry 1612, or the like) may use a supervised partitioning tree to identify the one or more features a model that shows a lack of robustness. To do so, the robustness remediation circuitry 1612 may create a diagnostic supervised partition tree on the covariate space using each observation's rPPV as the response. As such, at each leaf node, the robustness remediation circuitry 1612 may obtain the average rPPV for observations in that node. The variables of interest may be identified by the robustness remediation circuitry 1612 as those that have resulted in a node split, and particularly the nodes that result in the maximum difference between the average rPPV values of its leaf nodes. The robustness remediation circuitry 1612 may then use these set of variables to identify high volatility regions in the dataset and diagnosing these variables may further help reveal the causes of the volatility in the predictions of the given model.

FIGS. 17-22 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable an improved evaluation of model robustness. Example embodiments thus provide tools that overcome the problems faced by traditional model robustness evaluation techniques. By creating a pseudo distance measure, example embodiments set forth a thoughtful categorical perturbation technique that eliminates the possibility of perturbing data outside a given data envelope, which has been unavoidable in the past. Moreover, by leveraging an adaptive perturbation technique, example embodiments by applying perturbations of different strength to a dataset based on the context in which the data exists.

As these examples all illustrate, example embodiments contemplated herein provide technical solutions that solve real-world problems faced while evaluating model robustness. And while model robustness has been an issue for decades, the increasing complexity of machine learning models made available by recently emerging technology today has made this problem significantly more acute, as the demand for complex machine learning models has grown significantly even while the need to ensure model robustness has itself increased. At the same time, the recently arising ubiquity of discrete and adaptive perturbation techniques has unlocked new computer-implemented avenues for solving this problem that historically were not available, and example embodiments described herein thus deploy those computer-implemented techniques to offer a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for dynamic model robustness evaluation, the method comprising:
receiving, by communications hardware, a robustness assessment request, wherein the robustness assessment request comprises a plurality of assessment parameters;
retrieving, by an adaptive perturbation engine and based on the plurality of assessment parameters, (i) a model, (ii) a dataset, and (iii) a corresponding response set, wherein the dataset comprises a plurality of observations and one or more features;
determining, by the adaptive perturbation engine and based on the dataset, a data correlation set;
generating, by the adaptive perturbation engine and based on the dataset, an adaptive noise scale set for each observation of the plurality of observations;
generating, by the adaptive perturbation engine and based on all adaptive noise scale sets and the data correlation set, an adaptive perturbed response set;
determining, by the adaptive perturbation engine and based on the adaptive perturbed response set, a robustness result; and
causing, by a robustness remediation circuitry and based on the robustness result, performance of a robustness management action.

2. The method of claim 1, further comprising:
for a predetermined number of perturbations, iteratively:
generating, by the adaptive perturbation engine and based on the data correlation set, a noise set that comprises a plurality of perturbation values, wherein each particular perturbation value corresponds to a particular feature of the one or more features and a particular observation of the plurality of observations; and
determining, by the adaptive perturbation engine and based on the noise set and the adaptive noise scale set for each of the one or more features, an iteration specific adaptive perturbation set; and
determining, by the adaptive perturbation engine and based on all determined iteration specific adaptive perturbation sets, a perturbed dataset, wherein the adaptive perturbed response set is based on the perturbed dataset.

3. The method of claim 1, further comprising:
generating, by the adaptive perturbation engine and based on the dataset, a segmented feature set for each of the one or more features, wherein each segmented feature set separates a plurality of values that are associated with the plurality of observations and a particular feature of the one or more features into quantile bins;
determining, by the adaptive perturbation engine and based on the segmented feature set for each of the one or more features, a local standard deviation for each quantile bin; and
determining, by the adaptive perturbation engine and based on the local standard deviation for each quantile bin, an adaptive noise scale value for each quantile bin, wherein the adaptive noise scale set comprises the adaptive noise scale value for each quantile bin.

4. The method of claim 2, wherein the plurality of perturbation values are based on a Gaussian distribution.

5. The method of claim 2, wherein the iteration specific adaptive perturbation set is generated based on a predefined budget.

6. The method of claim 1, further comprising:
determining, by the robustness remediation circuitry and based on the adaptive perturbed response set, a root Perturbed Prediction Volatility (rPPV) for each observation of the plurality of observations; and
determining, by the robustness remediation circuitry and based on the rPPV for each observation, an Average root Perturbed Prediction Volatility (ArPPV), wherein the robustness result is based on the Average root Perturbed Prediction Volatility.

7. The method of claim 6, further comprising:
generating, by the robustness remediation circuitry, an observation subset based on whether the rPPV for each observation satisfies a rPPV threshold;
determining, by the robustness remediation circuitry and based on the observation subset, a population stability index (PSI) for each of the one or more features; and
identifying, by the robustness remediation circuitry, the one or more features that are associated with a lack of robustness.

8. The method of claim 6, further comprising:
generating, by the robustness remediation circuitry and based on the rPPV for each observation, a supervised partitioning tree, wherein the one or more features are response variables for the supervised partitioning tree and the rPPV is a predictor for the supervised partitioning tree; and
identifying, by the robustness remediation circuitry, the one or more features that are associated with a lack of robustness.

9. An apparatus for dynamic model robustness evaluation, the apparatus comprising:
communications hardware configured to receive a robustness assessment request, wherein the robustness assessment request comprises a plurality of assessment parameters;
adaptive perturbation engine configured to:
retrieve, based on the plurality of assessment parameters, (i) a model, (ii) a dataset, and (iii) a corresponding response set, wherein the dataset comprises a plurality of observations and one or more features,
determine, based on the dataset, a data correlation set,
generate, based on the dataset, an adaptive noise scale set for each observation of the plurality of observations,
generate, based on all adaptive noise scale sets and the data correlation set, an adaptive perturbed response set, and
determine based on the adaptive perturbed response set, a robustness result; and
robustness remediation circuitry configured to cause, based on the robustness result, performance of a robustness management action.

10. The apparatus of claim 9, wherein the adaptive perturbation engine is further configured to:
for a predetermined number of perturbations, iteratively:
generate, based on the data correlation set, a noise set that comprises a plurality of perturbation values, wherein each particular perturbation value corresponds to a particular feature of the one or more features and a particular observation of the plurality of observations; and
determine, based on the noise set and the adaptive noise scale set for each of the one or more features, an iteration specific adaptive perturbation set; and
determine, based on all determined iteration specific adaptive perturbation sets, a perturbed dataset, wherein the adaptive perturbed response set is based on the perturbed dataset.

11. The apparatus of claim 10, wherein the adaptive perturbation engine is further configured to:
generate, based on the dataset, a segmented feature set for each of the one or more features, wherein each segmented feature set separates a plurality of values that are associated with the plurality of observations and a particular feature of the one or more features into quantile bins;
determine, based on the segmented feature set for each of the one or more features, a local standard deviation for each quantile bin; and
determine, based on the local standard deviation for each quantile bin, an adaptive noise scale value for each quantile bin, wherein the adaptive noise scale set comprises the adaptive noise scale value for each quantile bin.

12. The apparatus of claim 10, wherein the plurality of perturbation values are based on a Gaussian distribution.

13. The apparatus of claim 10, wherein the iteration specific adaptive perturbation set is generated based on a predefined budget.

14. The apparatus of claim 9, wherein the robustness remediation circuitry is further configured to:
determine, based on the adaptive perturbed response set, a root Perturbed Prediction Volatility (rPPV) for each observation of the plurality of observations; and
determine, based on the rPPV for each observation, an Average root Perturbed Prediction Volatility (ArPPV), wherein the robustness result is based on the Average root Perturbed Prediction Volatility.

15. The apparatus of claim 14, wherein the robustness remediation circuitry is further configured to:
generate an observation subset based on whether the rPPV for each observation satisfies a rPPV threshold;
determine, based on the observation subset, a population stability index (PSI) for each of the one or more features; and
identify the one or more features that are associated with a lack of robustness.

16. The apparatus of claim 15, wherein the robustness remediation circuitry is further configured to:
generate based on the rPPV for each observation, a supervised partitioning tree, wherein the one or more features are response variables for the supervised partitioning tree and the rPPV is a predictor for the supervised partitioning tree; and
identify the one or more features that are associated with a lack of robustness.

17. A computer program product for dynamic model robustness evaluation, the computer program product comprising a non-transitory computer-readable storage medium storing instructions that, when executed by an apparatus, cause the apparatus to:
receive a robustness assessment request, wherein the robustness assessment request comprises a plurality of assessment parameters;
retrieve, based on the plurality of assessment parameters, (i) a model, (ii) a dataset, and (iii) a corresponding response set, wherein the dataset comprises a plurality of observations and one or more features;
determine, based on the dataset, a data correlation set;
generate, based on the dataset, an adaptive noise scale set for each observation of the plurality of observations;
generate, based on all adaptive noise scale sets and the data correlation set, an adaptive perturbed response set;
determine based on the adaptive perturbed response set, a robustness result; and
cause, based on the robustness result, performance of a robustness management action.

18. The computer program product of claim 17, wherein the instructions, when executed by the apparatus, further cause the apparatus to:
for a predetermined number of perturbations, iteratively:
generate, based on the data correlation set, a noise set that comprises a plurality of perturbation values, wherein each particular perturbation value corresponds to a particular feature of the one or more features and a particular observation of the plurality of observations; and
determine, based on the noise set and the adaptive noise scale set for each of the one or more features, an iteration specific adaptive perturbation set; and
determine, based on all determined iteration specific adaptive perturbation sets, a perturbed dataset, wherein the adaptive perturbed response set is based on the perturbed dataset.

19. The computer program product of claim 18, wherein the instructions, when executed by the apparatus, further cause the apparatus to:
generate, based on the dataset, a segmented feature set for each of the one or more features, wherein each segmented feature set separates a plurality of values that are associated with the plurality of observations and a particular feature of the one or more features into quantile bins;
determine, based on the segmented feature set for each of the one or more features, a local standard deviation for each quantile bin; and
determine, based on the local standard deviation for each quantile bin, an adaptive noise scale value for each quantile bin, wherein the adaptive noise scale set comprises the adaptive noise scale value for each quantile bin.

20. The computer program product of claim 18, wherein the plurality of perturbation values are based on a Gaussian distribution.

21-40. (canceled)
